(19) United States
(12) Patent Application Publication
(10) Pub. No.: US 2026/0071473 A1
(43) Pub. Date: Mar. 12, 2026

(54) HOME APPLIANCE

(71) Applicant: LG Electronics Inc., Seoul (KR)

(72) Inventors: Jaeun SHIN, Seoul (KR); Sanggyun LEE, Seoul (KR); Minho LEE, Seoul (KR)

(21) Appl. No.: 19/320,832

(22) Filed: Sep. 5, 2025

(30) Foreign Application Priority Data
Sep. 6, 2024 (KR) 10-2024-0121766
Aug. 27, 2025 (KR) 10-2025-0119780

(51) Int. Cl. E05F 1/12; E05D 3/12; F25D 23/02

(52) U.S. Cl. CPC E05F 1/1207; E05D 3/12; F25D 23/028; E05Y 2900/31

(57) ABSTRACT

A home appliance includes a cabinet providing a forward-opening storage compartment, a door rotatably provided at the front of the cabinet to open and close the storage compartment, a hinge fixed to the cabinet, the hinge including a hinge shaft rotatably supporting the door and a reference pin spaced from the hinge shaft, and an auto-closing device providing force to the door in a closing direction, the auto-closing device includes a lever that is rotatably coupled to the auto-closing device, receives torque from the auto-closing device, and includes a slit into which the reference pin is inserted. The slit includes a first region in which the reference pin is positioned in a state in which the door is closed and extending rearward with increasing distance from the rotation center of the lever.

### CROSS-REFERENCE TO RELATED APPLICATIONS

This application claims the benefit of Korean Patent Application No. 10-2024-0121766, filed on Sep. 6, 2024, and Korean Patent Application No. 10-2025-0119780, filed on Aug. 27, 2025. The disclosures of the prior applications are incorporated by reference in their entirety.

### BACKGROUND

### 1. Field

The present disclosure relates to home appliances such as refrigerators, and more specifically, to home appliances with doors.

### 2. Description of the Related Art

Home appliances have an internal storage or processing chamber and can supply cold air, heat, steam, or water to the storage or chamber to control or maintain the conditions of items contained therein. Examples of such home appliances include refrigerators for keeping food or beverages fresh, and clothing treatment apparatuses (e.g., Stylers) for deodorizing, drying, or refreshing clothing.

A door is positioned at the front of the storage compartment or processing chamber. Recently, home appliances are increasingly being used alongside furniture or other appliances. In this context, home appliances with doors that are thinner than conventional doors are being released to match the depth in the front-to-back direction with that of the furniture or other appliances.

Meanwhile, if the door of a home appliance such as a refrigerator is not completely closed, cold air from the storage compartment may escape, and to solve this problem, an ‘auto-closing’ function has been required to induce the door to automatically close when the door is opened at a certain angle or less.

If a device providing such an auto-closing function is attached to a hinge shaft and directly applies torque to the hinge shaft, a large force may be required to rotate the door. Consequently, the device may be bulky to provide such a large force. Patent Publication No. 10-2024-0057859 (hereinafter, “Prior Document 1”) discloses an auto-closing device that interacts with a hinge bracket body. The auto-closing device of Prior Document 1 has a potential problem in that, depending on the shape of the hinge bracket body, the force provided by the auto-closing device to the door may act in the direction of door opening.

Conversely, if the door closes rapidly, a shock may occur between the door and the cabinet.

Korean Patent Publication No. 10-2018-0119985 (hereinafter, “Prior Document 2”) discloses a refrigerator including a damper mounted in the cabinet and protruding forward. The damper of Prior Document 2 has a portion exposed to the outside when the door is opened.

### SUMMARY

An object of the present disclosure is to solve the aforementioned problems and other problems.

Another object may be to provide a home appliance equipped with an auto-closing device that provides a closing force to a door when the opening angle of the door is below a certain angle. Another object may be to provide a home appliance including an auto-closing device applicable to doors of various structures. For example, a home appliance including an auto-closing device applicable to a door whose rotation center varies depending on the opening angle of the door or a door thinner than conventional doors may be provided.

Another object may be to provide a home appliance in which an auto-closing device operates with a component other than a hinge shaft to close a door.

Another object may be to provide a home appliance equipped with an auto-closing device capable of closing a door with minimal force.

Another object may be to provide a home appliance that prevents a door from not closing by allowing the door to close naturally when the door is closed without a reaction force acting in the direction of door opening.

Another object may be to provide a home appliance in which a lever coupled to a driver of an auto-closing device has a simple structure.

Another object may be to provide a home appliance including a lever with a slit designed to take into account the direction of force applied to the lever during a door closing or opening process.

Another object may be to provide a home appliance in which impact does not occur between a reference pin and the slit of the lever during the door closing process.

Another object may be to provide a home appliance in which a clutch is provided within the driver of the auto-closing device.

Another object may be to provide a home appliance that reduces the impact between a cabinet and the door when the door is closed to promote smooth closing, and improves the operating feel.

The objects of the present disclosure are not limited to the objects mentioned above, and other objects not mentioned will be clearly understood by those skilled in the art from the description below.

In accordance with an aspect of the present disclosure, the above and other objects can be accomplished by the provision of a home appliance including an auto-closing device. The auto-closing device may apply force to a door in a closing direction. The auto-closing device may provide force in a closing direction to the door opened at a predetermined angle or less.

The home appliance includes a cabinet providing a storage compartment that opens forward, a door rotatably provided at the front of the cabinet to open and close the storage compartment, and a hinge including a hinge shaft that rotatably supports the door.

The hinge may be fixed to the cabinet.

The auto-closing device includes a driver and a lever rotatably coupled to the driver. The driver may provide torque to the lever. The driver may provide elastic force of a spring to the lever. The spring of the driver may be a torsion spring.

The hinge includes a reference pin, and the lever includes a slit into which the reference pin is inserted.

The reference pin may be spaced apart from the hinge shaft.

The reference pin may be positioned in the slit when the door is closed.

The slit may include a first region in which the reference pin is positioned when the door is closed. The lever may be rotatably coupled to the driver, and the first region may extend rearward with increasing distance from the rotation center of the lever. The rotation center of the lever may be provided by the driver. For example, the driver may include a lever shaft rotatably provided, and the lever may be coupled to the lever shaft and rotate integrally with the lever shaft. The lever shaft may serve as the central axis of rotation of the lever.

The slit may further include a second region extending away from the first region in a direction away from the rotation center of the lever. The second region may extend forward with increasing distance from the rotation center of the lever.

The first region may extend in a curved manner. The second region may extend in a curved manner. The radius of curvature of the first region may be greater than the radius of curvature of the second region. The radii of curvature of the first and second regions may refer to the radii of curvature of the longitudinal centerlines of the first and second regions.

The slit may further include a third region extending from the second region and open outward. The third region may extend in a straight line.

The driver may include a torsion spring. The torsion spring may have one end fixed. The one end of the torsion spring may be fixed to the driver or the door. For example, the one end of the torsion spring may be fixed to a housing or a cover of the driver. The driver may include a lever shaft that rotates integrally with the lever, and a clutch that selectively connects or disconnects the torsion spring and the lever shaft.

When the clutch connects the torsion spring and the lever shaft, at least a portion of the torsion spring may rotate along with the lever shaft when the lever shaft rotates. The at least portion may be an opposite end of the first end. In this state, when the lever shaft rotates due to an external force, the elastic energy stored in the torsion spring may increase. When the torsion spring is rotated from a free state and no external force is applied to the lever shaft, or when the elastic force of the torsion spring is greater than the external force applied to the lever shaft, the lever shaft may rotate due to the elastic force of the torsion spring.

When the clutch disconnects the torsion spring and the lever shaft, the torsion spring may not rotate even when the lever shaft rotates.

The clutch may connect the torsion spring and the lever shaft when the rotation angle of the lever is equal to or less than a first angle based on the rotational position of the lever when the door is closed.

The clutch may disconnect the torsion spring from the lever shaft when the rotation angle of the lever is greater than the first angle.

The rotation angle of the lever may be defined based on the position of the lever when the door is closed. The rotation angle of the lever may be defined as a direction in which the lever rotates during the door opening process based on the position of the lever when the door is closed. The rotation angle of the lever in a specific state may be defined as an angle between the position of the lever when the door is closed and the position of the lever in the specific state.

The clutch may restrict rotation of the lever shaft when the rotation angle of the lever is equal to or greater than a second angle that is greater than the first angle.

The reference pin may be positioned in the first region of the slit when the rotation angle of the lever is less than the first angle.

The reference pin may be positioned in the second region of the slit when the rotation angle of the lever is between the first angle and the second angle.

When the reference pin is positioned in the slit, the rotation angle of the lever may be greater than a rotation angle of the door.

The rotation angle of the door may be defined as an angle between the door and the cabinet.

The door may include a guide member into which the hinge shaft is inserted.

The lever may be spaced apart from the guide member in the width direction of the door.

The hinge shaft may include a first hinge shaft and a second hinge shaft that are spaced apart from each other in a horizontal direction.

The guide member may include a shaft insertion groove into which the first and second hinge shafts are inserted and which extends in a curved shape.

Based on the door rotating relative to the cabinet, the first and second hinge shafts may slide relative to the shaft insertion groove such that a position of a rotation center of the door is changed.

The front portion of the lever may include a front edge disposed parallel to the front surface of the door when the door is closed.

The door may include a cover that protrudes downward from the lower end of the door and is disposed forward of the front portion of the lever.

In a state in which the door is open and the reference pin is removed from the slit, the rear portion of the lever may include a rear edge parallel to the rear surface of the door.

The lever may include a coupling portion fixed to the cabinet. The coupling portion may include a fastening hole through which a fastening member passes.

The hinge may include a supporter protruding forward from the coupling portion and having the reference pin provided therein.

The fastening hole may be spaced apart from the reference pin in the width direction of the cabinet.

An angle between the centerline of the first region and a line connecting the center of the reference pin and the rotational center of the lever when the door is closed may be greater than 90 degrees and less than 180 degrees. The centerline of the first region may refer to the longitudinal centerline of the first region.

The first region may include a portion extending rearward from the inner end of the slit. The inner end of the slit may refer to a portion of the slit closest to the rotation center of the lever.

The first region may include a portion extending in a direction perpendicular to the radial direction of the lever.

The reference pin may include a first reference pin positioned in the first region when the door is closed, and a second reference pin positioned in the second region when the door is closed.

Specific details of other embodiments are included in the detailed description and drawings.

According to at least one embodiment of the present disclosure, a home appliance equipped with an auto-closing device that provides a closing force to a door when the opening angle of the door is below a certain angle. This allows a refrigerator door to automatically close, thereby improving user convenience and energy efficiency.

According to at least one embodiment of the present disclosure, a home appliance including an auto-closing device applicable to doors of various structures. For example, the auto-closing device may not directly act on a hinge shaft, but rather may provide the closing force to the door through the operations of a driver, a lever, and a reference pin. This structure allows the auto-closing device to be applied to a door whose rotation center varies depending on the opening angle of the door.

Furthermore, the auto-closing device does not directly act on the hinge shaft and can operate independently of the hinge shaft through the lever that interacts with the reference pin.

Furthermore, since the auto-closing device does not directly act on the hinge shaft, and the lever applies force to the reference pin to close the door, the moment arm can be lengthened. Therefore, the driver can close the door with minimal force. This reduces the volume of the driver and allows for application to doors with thin front-to-back thickness.

Furthermore, during the door closing process, a reference pin fixed to the cabinet is inserted into a slit formed in the lever. This ensures that when the lever is rotated by the driver, the point of force applied is always located behind the reference pin. This prevents the occurrence of reaction force that opens the door when the auto-closing device closes the door. Consequently, it is possible to prevent the door from not closing.

According to at least one embodiment of the present disclosure, a clutch can be installed within the driver, thereby simplifying the lever structure. In particular, by utilizing the clutch mechanism of the driver without a separate locking member within the lever, component reliability can be enhanced and assembly can be improved.

According to at least one embodiment of the present disclosure, the slit of the lever has a first region that is directed forward and convexly curved rearward with decreasing distance to the rotation center of the lever, thereby allowing the force applied by the lever to the reference pin to be directed forward or at a small angle relative to the front. This allows the torque of the driver to be efficiently utilized for closing the door.

Furthermore, the slit has a second region that is directed forward and convexly curved rearward with increasing distance from the rotation center of the lever from the first region, thereby allowing the inclinations of the first and second regions to be continuous or nearly continuous. This allows the reference pin to move smoothly along the slit during the door closing process. Furthermore, the door can be closed naturally without abrupt changes in speed during the closing process.

According to at least one embodiment of the present disclosure, the lever can be fixed at a constant rotational position when the door is opened through a structure of an outer end of the lever located opposite the rotation center of the lever, for example, a third region extending from the second region of the slit, or a structure having a curvature of the outer end of the second finger (a portion located at the rear of the slit). This allows the reference pin to be inserted into the slit without colliding with the lever when the door is closed.

According to at least one embodiment of the present disclosure, it is possible to provide a home appliance including a soft closing device on a door, which reduces the impact between a cabinet and the door when the door is closed, thereby ensuring smooth closing and improving the operating feel.

### BRIEF DESCRIPTION OF THE DRAWINGS

FIG. 1 is a front view of a refrigerator according to an embodiment of the present disclosure.

FIG. 2 is a perspective view of a clothing treatment apparatus according to another embodiment of the present disclosure.

FIG. 3 is a perspective view and an enlarged view of a door illustrated in FIG. 1.

FIG. 4 is an exploded perspective view of components illustrated in FIG. 3, including a door, a hinge, an auto-closing device, and a soft closing device of a home appliance according to a first embodiment of the present disclosure.

FIGS. 5A to 5C are enlarged views of the part illustrated in FIG. 1, wherein (A) is the interior of the door, (B) is a front view with the cover removed, and (C) is a front view.

FIG. 6 and FIG. 7 are exploded perspective views of the auto-closing device illustrated in FIG. 4.

FIG. 8 is a bottom view of a door illustrating an auto-closing system of a home appliance according to a second embodiment of the present disclosure.

FIGS. 9A to 9C are diagrams illustrating the positions of a lever and a reference pin according to the opening angle of the door illustrated in FIG. 8.

FIG. 10 is a graph showing the torque of a driver, clutch engagement and disengagement, and lever engagement according to the door opening angle of the home appliance according to an embodiment of the present disclosure.

FIGS. 11A and 11B are bottom views of a lever of an auto-closing device of a home appliance according to third and fourth embodiments of the present disclosure.

FIG. 12 is a bottom view of a door illustrating an auto-closing system for a home appliance according to a fifth embodiment of the present disclosure.

FIGS. 13A to 13C to 15A to 15D are diagrams illustrating the positions of the lever and reference pin according to the opening angle of the door illustrated in FIG. 12.

FIGS. 16 and 17A to 17D are an exploded perspective view illustrating a hinge and a guide member of a home appliance according to another embodiment of the present disclosure, and a diagram illustrating the positions of the hinge and guide member according to the opening angle of the door.

FIG. 18 is a diagram illustrating an auto-closing system a home appliance according to a sixth embodiment of the present disclosure.

FIG. 19 is a diagram illustrating an auto-closing system of a home appliance according to a seventh embodiment of the present disclosure.

FIG. 20 is a bottom view of a door illustrating an auto-closing system of a home appliance according to an eighth embodiment of the present disclosure.

FIGS. 21A to 21D are diagrams illustrating the positions of the lever and reference pin according to the opening angle of the door illustrated in FIG. 20.

FIG. 22 is a bottom view of the door illustrating the auto-closing system of the home appliance according to the first embodiment of the present disclosure illustrated in FIG. 4.

FIGS. 23A to 23D are diagrams illustrating the positions of the lever and the reference pin according to the opening angle of the door illustrated in FIG. 22.

FIG. 24 is a perspective view illustrating the lever of the home appliance according to an embodiment of the present disclosure.

FIG. 25 is an exploded perspective view illustrating an auto-closing device of a home appliance according to another embodiment of the present disclosure.

### DETAILED DESCRIPTION

Hereinafter, embodiments disclosed in this specification will be described in detail with reference to the attached drawings. Regardless of the reference numerals used in the drawings, identical or similar components will be assigned the same reference numerals, and redundant descriptions thereof will be omitted.

When a component is referred to as being “coupled” or “connected” to another component, it should be understood that the component may be directly coupled or connected to the other component, but that other components may also be present in between. Conversely, when a component is referred to as being “directly coupled” or “directly connected” to another component, it should be understood that there are no other components present in between.

The singular expression includes plural expression unless the context clearly indicates otherwise.

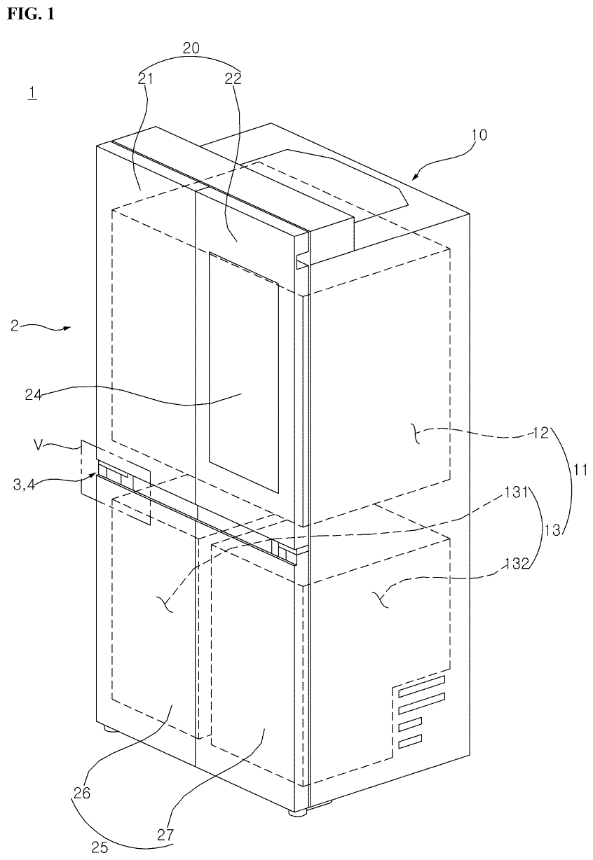

Referring to FIG. 1, a home appliance according to an embodiment of the present disclosure may be a refrigerator. The refrigerator 1 includes a cabinet 10 providing a storage compartment 11 and a door 2 for opening and closing the storage compartment 11.

The storage compartment 11 may be openable toward the front. The storage compartment 11 may provide a space and/or configuration for storing food or beverages inside. The storage compartment 11 may be configured to open toward the front, facilitating user access and food storage.

A plurality of storage compartments 11 may be provided. For example, the storage compartment 11 may include an upper storage compartment 12 and a lower storage compartment 13 partitioned vertically. The upper storage compartment 12 may be provided as a refrigerator compartment, and the lower storage compartment 13 may be provided as a freezer compartment. However, the configuration of the refrigerator and freezer compartments is not limited thereto.

The door 2 is provided at the front of the cabinet 10 and can open and close the storage compartment 11. The door 2 is rotatably provided at the front of the cabinet 10 and can open and close the storage compartment 11.

The door 2 may include an upper door 20 that opens and closes the upper storage compartment 12. The door 2 may include a lower door 25 that opens and closes the lower storage compartment 13.

A plurality of doors 2 may be provided. A plurality of doors 2 may open and close a single storage compartment. For example, the single upper storage compartment 12 may be opened and closed by a first door 21 and a second door 22. That is, the first door 21 can open and close a part of the upper storage compartment 12 (the left side in FIG. 1), and the second door 22 can open and close another part of the upper storage compartment 12 (the right side in FIG. 1).

A plurality of doors 20 may be provided, and a single storage compartment may be opened and closed by a single door. For example, the lower storage compartment 13 may be divided into two storage compartments 131 and 132 by left and right partitions, and the lower door 25 for opening and closing the lower storage compartment 13 may include a first lower door 26 for opening and closing a first lower storage compartment 131 and a second lower door 27 for opening and closing a second lower storage compartment 132.

The aforementioned multiple storage compartments 11 and doors 2 may be configured differently. For example, the upper storage compartment 12 may be partitioned into left and right sections, or the lower storage compartment 13 may be provided as a single unit without being partitioned into left and right sections.

Food may be stored in the storage compartment 11. Cool air may be supplied to the storage compartment 11. The door 2 may close the storage compartment 11 to prevent the cool air from leaking to the outside.

The refrigerator 1 may include a refrigeration cycle. The refrigeration cycle may exchange heat with air to supply cool air to the storage compartment.

Shelves and/or drawers may be disposed inside the storage compartment 11. The door 2 may also include shelves to store food.

A storage space may also be formed inside the door 2, increasing storage capacity.

The door 2 may further include a window 24. The window 24 may be formed of a transparent or translucent material, allowing the interior of the storage compartment to be visually inspected from the outside.

The window 24 may enable the food inside to be identified from the outside when the door or the interior of the storage compartment is illuminated.

The window 24 may have a display function. Therefore, the window 24 may also be referred to as a display 24. The window 24 may display the state of the refrigerator 1 and the state of the inside of the storage compartment 11.

The window 24 may serve as a user interface means and receive commands from a user. For example, the window 24 may include a touch display that operates by detecting touch input of a user.

The refrigerator 1 may include a hinge 3 that connects the cabinet 10 and the door 2. The hinge 3 may rotatably support the door 2 relative to the cabinet 10. The door 2 may be rotatably coupled to the cabinet 10 by the hinge 3.

The hinge 3 may connect the upper and lower portions of the door 2 to the cabinet 10. For example, the hinge 3 may be provided at each of the upper and lower portions of the upper door 20, and the hinge 3 may also be provided at each of the upper and lower portions of the lower door 25.

The refrigerator 1 may include an auto-closing device 4 that provides a closing force to the door 2. The auto-closing device 4 may be provided at the upper or lower portion of the door 2, or at each of the upper and lower portions. A detailed description of the auto-closing device 4 will be described later.

The left-right direction (the direction in which the first and second doors 21 and 22 are arranged) of FIG. 1 may be referred to as the width direction of the refrigerator, the width direction of the cabinet 10, or the width direction of the door 2.

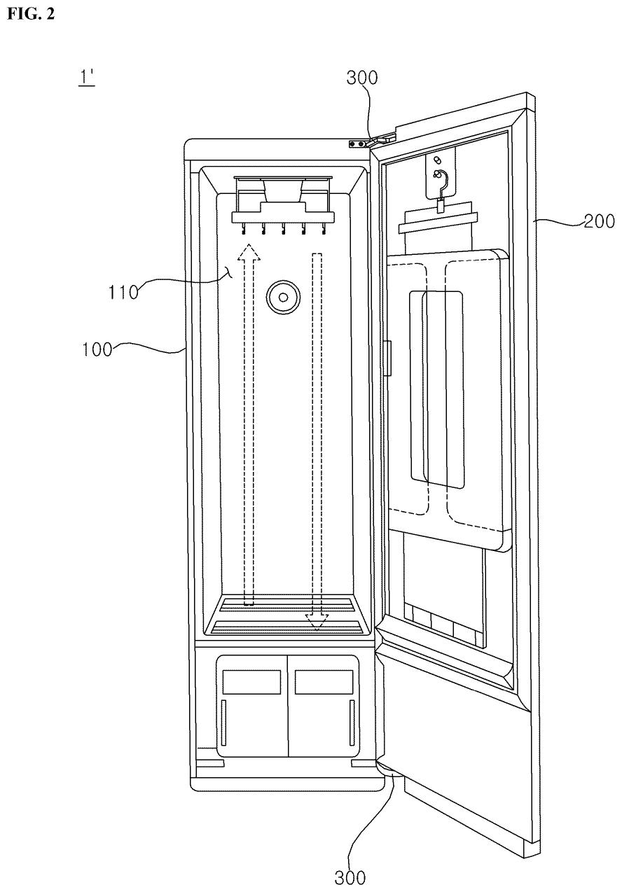

Referring to FIG. 2, a home appliance according to an embodiment of the present disclosure may be a clothing treatment apparatus 1′. The clothing treatment apparatus 1′ includes a cabinet 100 providing a treatment chamber 110, a door 200 for opening and closing the treatment chamber 110, and a hinge 300 for rotatably connecting the door 200 to the cabinet 100. The hinge 300 may disposed at an upper part and/or a lower part of the door 200.

The treatment chamber 110 may be opened forward. The treatment chamber 110 may provide an internal space for storing or treating clothing. The treatment chamber 110 may be configured to be open forward to facilitate user access.

The clothing treatment apparatus 1′ can supply air with controlled temperature and humidity into the treatment chamber 110 and take the air back. In addition, the clothing treatment apparatus 1′ can supply steam into the treatment chamber 110. Clothing, etc., can be hung inside the treatment chamber 110.

Hereinafter, the present disclosure will be described using the refrigerator 1 as an example, but the present disclosure can also be applied to the clothing treatment apparatus 1′. For example, the components mounted in the door 2 and cabinet 10 of the refrigerator 1 can be mounted in the door 200 and cabinet 100 of the clothing treatment apparatus 1′. For example, the hinge 300 of the clothing treatment apparatus 1′ may have the same structure as the hinge 3 of the refrigerator 1, and the auto-closing device 4 may be mounted on the door 200 of the clothing treatment apparatus 1′. Additionally, a soft closing device 7 may be mounted on the door 200 of the clothing treatment apparatus 1′.

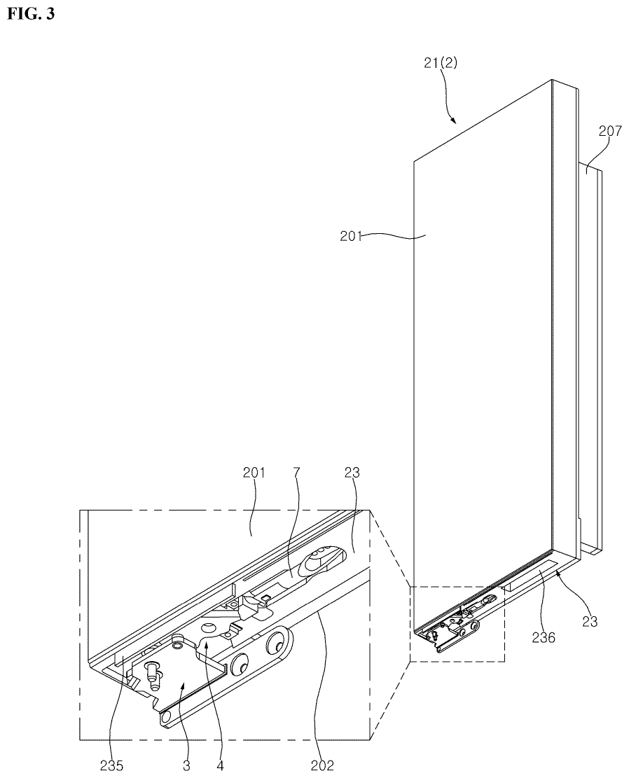

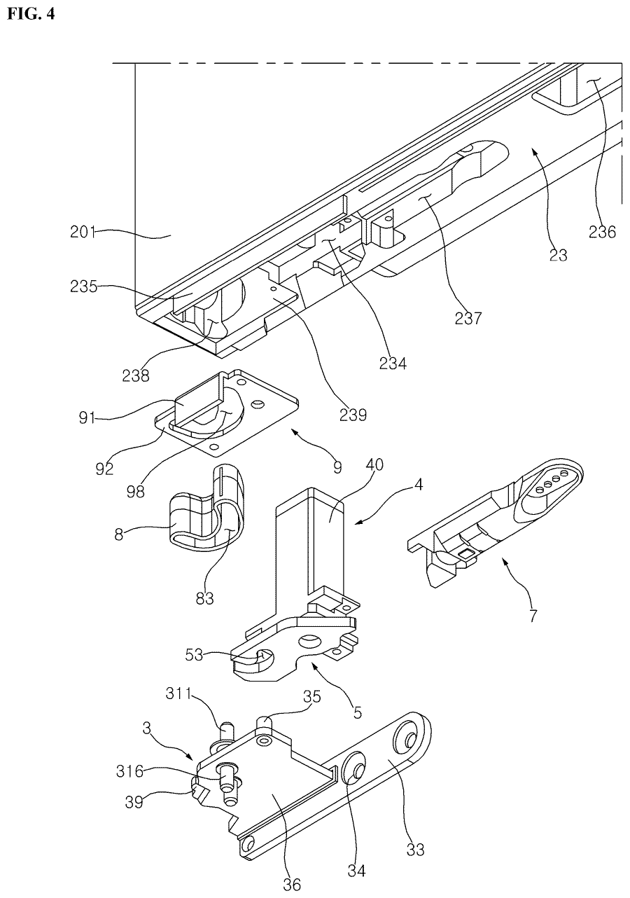

Hereinafter, the door 2 will be described with reference to FIGS. 3 and 4. The first door 21 will be described as an example, but the features described below can also be applied to the second door 22 or the lower door 25.

Referring to FIGS. 3 and 4, the door 2 may include a door panel 201 forming the exterior. The door panel 201 may provide the front surface of the door 2. Hereinafter, the door panel 201 may also be referred to as the front surface of the door or the front surface of the refrigerator.

The door 2 may include a front surface 201 and a rear surface 202. The front surface 201 constitutes the outer surface of the door, and the rear surface 202 constitutes the inner surface facing the storage compartment 11.

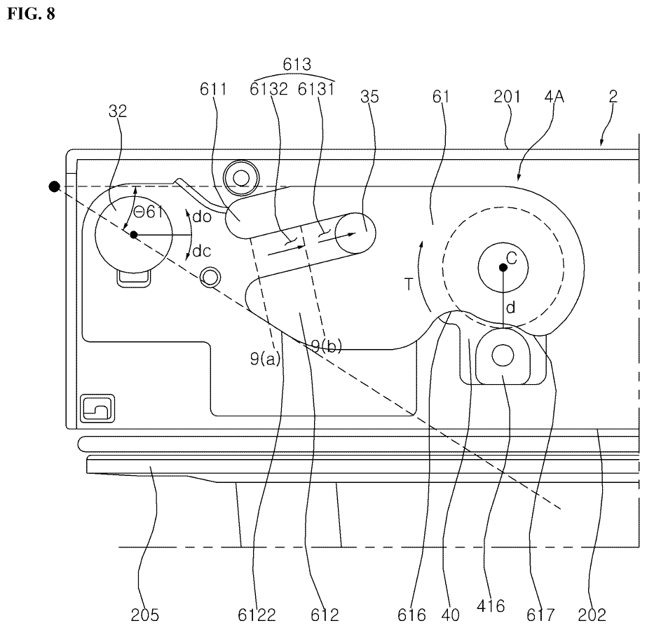

A gasket (205, refer to FIG. 8) may be provided on the rear surface 202 of the door 2 to seal the storage compartment 11 when the door 2 is closed.

A filler 207 may be provided on one side of the door 2. The filler 207 may be provided on the rear surface of the door 2.

The filler 207 is configured to close the gap between the first door 21 and the second door 22, thereby improving insulation and appearance quality when both doors are closed.

The filler 207 may be rotatably installed and may be linked to the opening and closing operations of the door.

The door 2 may include a lower cap deco 23 that provides the lower surface of the door 2. The lower cap deco 23 may be attached to the lower end of the front surface 201 and the lower end of the rear surface 202 of the door 2.

The door 2 may include an upper cap deco that provides the upper surface of the door 2. The upper cap deco may be attached to the upper end of the front surface 201 and the upper end of the rear surface 202 of the door 92.

Accordingly, the door 2 may have an internal space, and the internal space of the door 2 may be filled with an insulation material. This allows the storage compartment 11 to be insulated from the outside when the door 2 closes the storage compartment 11.

Hereinafter, the lower cap deco 23 will be referred to as a cap deco 23, and the description of the cap deco 23 can be applied directly or similarly to the upper cap deco.

A handle 236 may be provided on the lower surface of the door 2. The handle 236 may be recessed upward from the lower surface of the door 2. The handle 236 may be located on the opposite side of the hinge 3 in the width direction of the door 2.

The handle 236 may be provided in the cap deco 23.

The hinge 3 provided on the lower surface of the door 2 may be coupled to the lower surface of the door 2, and the hinge provided on the upper surface of the door 2 may be coupled to a mounting part provided on the upper surface or upper portion of the door 2. Hereinafter, the hinge 3 and a guide member 8 provided at the bottom of the door 2 will be described as an example, and the descriptions can also be applied to hinges and guide members provided at other locations.

The hinge 2 is secured to the cabinet 10 and can support the door 2. The hinge 3 may include a hinge shaft 31 that rotatably supports the door 2. The hinge 3 may include a coupling portion 33 fixed to the cabinet 10.

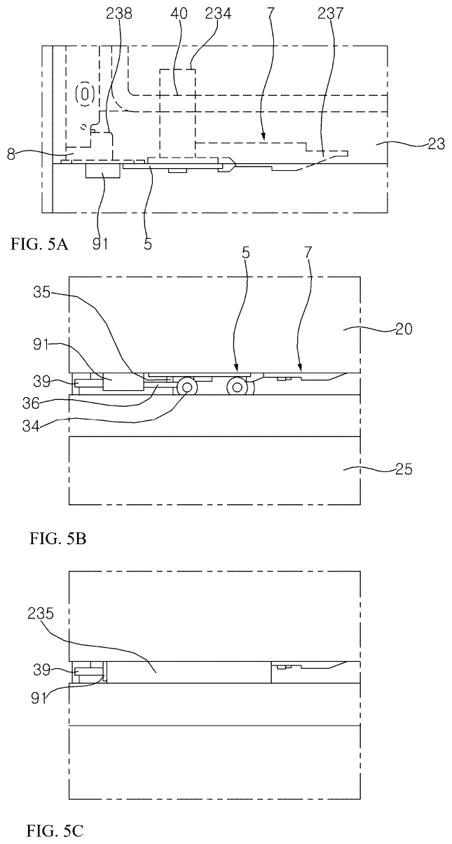

A fastening hole 34 is formed in the coupling portion 33, allowing the hinge to be secured to the cabinet via a fastening member. The fastening hole 34 may be positioned at a position spaced apart from a reference pin 35 which will be described below in the width direction of the cabinet 10 (refer to FIG. 5B). Accordingly, the hinge can be secured to the cabinet via the fastening member without structural interference.

The hinge 3 may include a supporter 36 that protrudes forward from the cabinet 10. The supporter 36 may protrude forward from the coupling portion 33. The supporter 36 may be disposed horizontally.

The hinge shaft 31 may protrude from the supporter 36. The hinge shaft 31 may protrude vertically from the supporter 36.

The hinge provided on the lower side of the upper door 20 and the hinge provided on the upper side of the lower door 25 may have hinge shafts 311 and 316 protruding upward and downward from the single supporter 36. That is, the hinge shaft 311 protruding upward from the supporter 36 may support the lower side of the upper door 20, and the hinge shaft 316 protruding downward from the supporter 36 may support the upper side of the lower door 25.

The door 2 may include the guide member 8 coupled to the hinge 3. The guide member 8 may be inserted into the lower surface or upper surface of the door 2.

The guide member 8 may include a shaft insertion groove 83 into which the hinge shaft 31 is inserted. The door 2 can be opened and closed by the hinge shaft 31 rotating in the shaft insertion groove 83 or moving along the shaft insertion groove 83.

When the door 2 opens and closes as the hinge shaft 31 moves along the shaft insertion groove 83, the position of the rotation center of the door 2 can change depending on the degree of opening of the door 2. This provides the advantage of preventing the door from interfering with other furniture or storage units placed next to the refrigerator when opened.

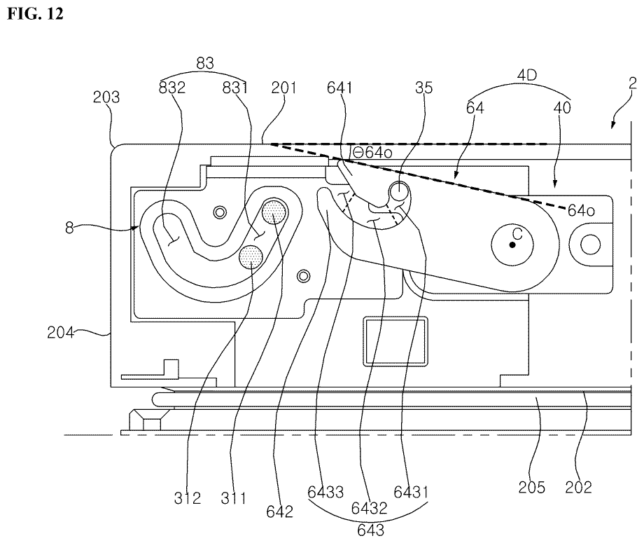

However, the structure of the hinge 3 and guide member 8 makes it difficult to close the door by directly applying torque to the hinge shaft. The auto-closing device 4 of the present disclosure can also be applied to the door 2 that opens and closes as the hinge shaft 31 moves along the shaft insertion groove 83. A detailed description of the structure of the guide member 8 and the movement of the hinge shaft 31 will be described later with reference to FIGS. 12 to 15.

According to an embodiment of the present disclosure, the door 2 may be automatically closed even when a user does not completely close the door 2. Such a function may be implemented through interaction between the auto-closing device 4 provided at the door 2 and the reference pin 35 provided at the cabinet 10. The auto-closing device 4 and the reference pin 35 together may be referred to as an auto-closing system. The auto-closing system may also be understood as a concept further including the hinge 3 that connects the door 2 and the cabinet 10.

The auto-closing system may provide a force in a closing direction of the door 2 by interaction between the auto-closing device 4 and the reference pin 35 when the door 2 is opened within a predetermined angle. For example, when the door 2 is opened/closed within a certain angle, the reference pin 35 may be positioned in a slit 53 of a lever 5 described below, and a driving unit 40 may rotate the lever 5. Accordingly, even if the user does not completely close the door 2, the door 2 may be automatically closed. Hereinafter, the auto-closing system will be described.

The auto-closing device 4 may be provided on the lower surface of the door 2.

The auto-closing device 4 may provide a force to close the door 2. When the angle between the cabinet 10 and the door 2 is equal to or less than a predetermined angle while the door 2 is open, the auto-closing device 4 may provide a force to close the door.

The auto-closing device 4 may include a driver 40 and a lever 5 coupled to the driver 40. The lever 5 may be rotatably coupled to the driver 40. The driver 40 may provide torque to the lever 5. The lever 5 may rotate in accordance with the opening and closing operation of the door 2.

The driver 40 may be spaced apart from the hinge shaft 31 in the rotational radius direction of the door 2. The auto-closing device 4 may close the door 2 by applying force to the hinge 3 via the lever 5. The lever 5 may apply force to a component of the hinge 3 other than the hinge shaft 31.

The hinge 3 may include a reference pin 35 to which the lever 5 applies force. The reference pin 35 may be spaced apart from the hinge shaft 31. The reference pin 35 may be provided on the supporter 36. The position of the reference pin 35 with respect to the cabinet 10 may be fixed. The reference pin 35 may protrude vertically from the supporter 36. The reference pin 35 may extend parallel to the hinge shaft 31.

Meanwhile, although the reference pin 35 has been described as a subordinate component of the hinge 3, the reference pin 35 may be configured as a component separate from the hinge 3. For example, instead of protruding from the support 36 of the hinge 3, the reference pin 35 may be formed as a separate component independent of the hinge 3, and the hinge 3 and the reference pin 35 may be respectively fixed to the cabinet 10.

The lever 5 may include a slit 53 into which the reference pin 35 is inserted. The reference pin 35 may slide in or out of the slit 53 according to the opening and closing operation of the door 2. Depending on the opening angle of the door 2, the reference pin 35 may slide in the slit 53 of the lever 5, and the lever 5 may rotate. Alternatively, the position of the reference pin within the slit 53 and the opening angle of the door 2 may be determined depending on the rotation angle of the lever 5. Sliding of the reference pin 35 in the slit 53 may mean that, since the reference pin 35 is fixed, the relative position of the reference pin 35 with respect to the slit 53 changes according to rotation and movement of the lever 5.

A soft closing device 7 may be provided on the lower surface of the door 2.

The soft closing device 7 may contact the lever 5 and provide a decelerating force during the door closing process.

This reduces the impact on the door and enables a smoother and more stable closing operation.

The door 2 may include a stopper 9. The stopper 9 may prevent the door 2 from opening beyond a set angle. For example, the set angle may be set within a range of 100 to 180 degrees.

The stopper 9 may include a stopper body 91 that protrudes downward from the lower surface of the door 2.

The hinge 3 may include a stopper contact portion 39. The stopper contact portion 39 may be provided on the supporter 36. The stopper contact portion 39 may be formed on the front portion of the supporter 36 and the outer portion in the width direction of the cabinet.

During the opening process of the door 2, the stopper body 91 may contact the stopper body contact portion 39. Accordingly, the maximum opening angle of the door 2 may be limited. The maximum opening angle of the door 2 may refer to the aforementioned set angle.

The stopper 9 may include a stopper bracket 92. The stopper bracket 92 may be mounted on the lower surface of the door 2.

A hole 98 may be formed in the stopper bracket 92. The hole 98 can penetrate the stopper bracket 92 vertically. The guide member 8 can be inserted into the hole 98. The guide member 8 can pass through the stopper bracket 92 vertically.

The stopper body 91 may be positioned behind a cover 235, which will be described later. A portion of the stopper body 91 may overlap the cover 235 in the front-to-back direction, and the remaining portion may protrude outwardly in the width direction of the door 2 from the cover 235.

The cover 235 may be provided in front of the lever 5. The cover 235 may protrude downward from the lower surface of the door 2.

The cover 235 serves as an exterior component that conceals mechanical parts exposed at the lower end of the lever 5 or the door 2, thereby providing both aesthetic appeal and safety.

The cover 235 may be positioned behind the front surface 201 of the door.

Referring to FIGS. 4 and 5, the cap deco 23 may include a guide housing 238.

The guide housing 238 may accommodate the guide member 8. The guide member 8 may be mounted and secured to the guide housing 238.

The guide housing 238 may be recessed upward from the lower surface of the door 2. The guide housing 238 may have a shape corresponding to the guide member 8.

The guide housing 238 may be provided in a stopper mounting portion 239. The guide housing 238 may be recessed upward from the stopper mounting portion 239.

The cap deco 23 may include an auto-closing receiving portion 234 in which the auto-closing device 4 is disposed. The auto-closing receiving portion 234 may be recessed upward from the lower surface of the door 2 to provide a space for accommodating the auto-closing device 4. The cap deco 23 may include a soft-closing receiving portion 237 in which the soft closing device 7 is mounted. The soft-closing receiving portion 237 may be recessed upward from the lower surface of the door 2.

At least a portion of each of the guide member 8, the stopper 9, the auto-closing device 4, and the soft closing device 7 can be covered from the front outside through the guide housing 238, the stopper mounting portion 239, the auto-closing receiving portion 234, and the soft-closing receiving portion 237 of the cap deco 23. For example, the driver 40 can be covered from the front outside by the cap deco 23, and the lever 5 is positioned lower than the lower surface of the door 2 and thus may not be hidden by the cap deco 23. For example, the upper portion of the soft closing device 7 can be covered from the front outside by the cap deco 23, and the lower portion thereof protrudes downward from the lower surface of the door 2 and thus may not be hidden by the cap deco 23. For example, at least a portion of the stopper body 91 may protrude downward from the lower surface of the door 2 and thus may not be covered from the front outside by the cap deco 23.

The cover 235 may be positioned in front of the lever 5 to cover the lever 5 from the front outside. Furthermore, a portion of the soft closing device 7 that contacts the lever 5 may be covered by the cover 235.

Furthermore, a portion of the stopper body 91 may be positioned behind the cover 235 to be covered from the front outside. The outer end of the stopper body 91 is positioned outside the cover 235 in the width direction of the cabinet 10 and thus the stopper body 91 may be exposed to the front. This allows a portion of the stopper body 91 to be covered by the cover body 235, and when the door 2 is opened at the maximum angle, the outer end of the stopper body 91 can contact the stopper contact portion 39.

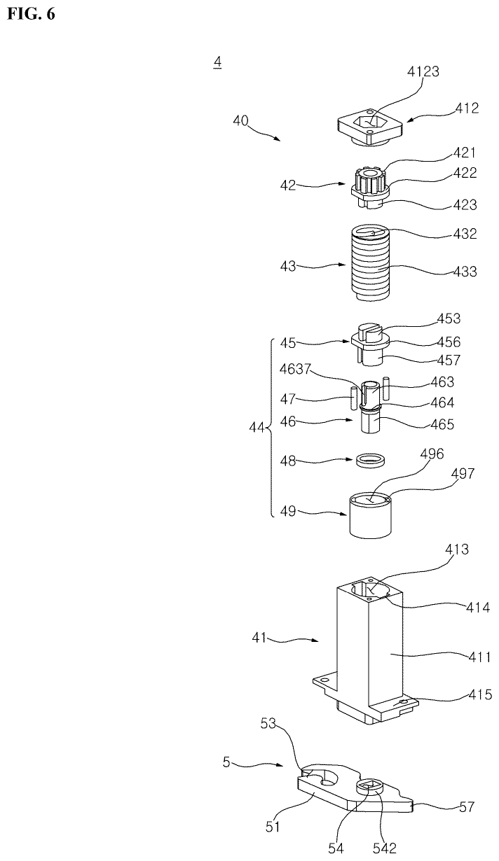

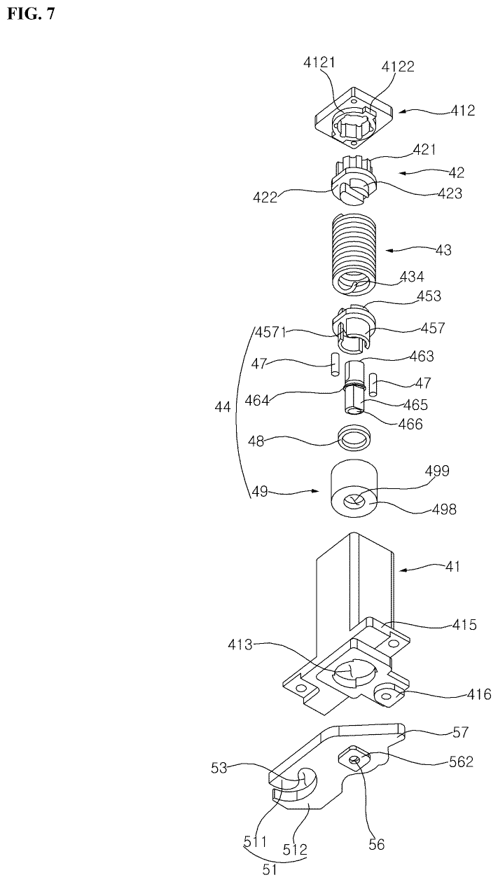

Referring to FIGS. 6 and 7, the driver 40 may include a housing 41. The housing 41 may be secured to the cabinet 10 and may provide an internal space 413 for accommodating a plurality of components therein.

The upper portion of the housing 41 may be open, and a housing cover 412 may be coupled to the upper end of the housing 41. The housing cover 412 may cover the housing 41. The housing cover 412 may include a first protrusion 4121 protruding downward. The first protrusion 4121 may be inserted into the internal space 413 of the housing 41, thereby coupling the housing cover 412 to the housing 41.

The housing 41 may include a coupling groove 414 extending outward from the space 413. The housing cover 412 may include a second protrusion 4122 inserted into the coupling groove 414.

The second protrusion 4122 may protrude outward from the outer periphery of the first protrusion 4121. The cover 412 may be secured to the housing 41 by being inserted into the coupling groove 414 of the housing 41. The cover 412 may be restrained to the housing 41 so as not to rotate.

A spring 43, a clutch 44, a lever shaft 46, etc. may be inserted into the internal space 413 of the housing 41. These elements may be inserted from the upper side of the housing 41 before the housing cover 412 is coupled to the housing 41.

The driver 40 may include the spring 43. The spring 43 may be a torsion spring that provides torque. The spring 43 may be mounted to provide torque in the direction in which the door 2 closes.

The driver 40 may include a holder 42 to which the spring 43 is coupled. One end 432 of the spring 43 may be coupled and/or fixed to the holder 42.

The holder 42 may be coupled and/or fixed to the housing cover 412. The holder 42 may include a fixing portion 421 extending upward. The fixing portion 421 may be inserted into an insertion hole 4123 formed in the cover 412.

The holder 42 may include a support portion 422. The support portion 422 may have a width greater than that of the fixing portion 421. The support portion 422 may be in contact with the lower surface of the housing cover 412.

The holder 42 may include a first spring coupling portion 423. One end 432 of the spring may be coupled to the first spring coupling portion 423. The first spring coupling portion 423 may protrude downward from the lower surface of the support portion 422. The support portion 422 may support the upper end of the spring 43.

The driver 40 may provide rotational force to the lever 5 through the operations of the spring 43, the clutch 44, and the shaft 46.

The spring 43 may include one end 432 and the other end 434. A spiral portion 433 extending spirally may be formed between the one end 432 and the other end 434. The spring 43 is configured as a torsion spring and may generate rotational torque in a certain direction.

The shaft 46 is connected to the spring 43 and can receive torque. The shaft 46 is coupled to the lever 5 and can rotate integrally with the lever 5.

The clutch 44 is positioned between the spring 43 and the shaft 46, selectively controlling connection of the spring 43 and the shaft 46. That is, the clutch 44 can selectively connect or disconnect the spring 43 and the shaft 46. The clutch 44 may connect or disconnect the spring 43 and the shaft 46 based on the rotation angle of the lever 5.

For example, when the door 2 is closed, the clutch 44 connects the spring 43 and the shaft 46 while the lever 5 rotates to a preset angle, and when the lever 5 rotates further, the clutch 44 can disconnect the spring 43 and the shaft 46. The preset angle is referred to as a switching angle. The “connection” is also called “coupling.”

When the lever 5 or the shaft 46 rotates due to an external force, the elastic energy stored in the spring 43 can increase. When the spring 43 is rotated from a free state and no external force is applied to the lever 5 and the shaft 46, or when the elastic force of the spring 43 is greater than the external force applied to the lever 5 and the shaft 46, the lever 6 and the shaft 46 can be rotated by the elastic force of the spring 43. When the clutch 44 releases connection between the spring 43 and the shaft 46, the spring 43 may not rotate even if the lever 5 and the shaft 46 rotate.

The clutch 44 can restrict or release the rotation of the shaft 46. The clutch 44 can restrict or release the rotation of the shaft 46 based on the rotation angle of the lever 5. For example, when the rotation angle of the lever 5 is equal to or greater than a locking angle that is greater than the switching angle, the clutch 44 can restrict the rotation of the shaft 46, and when the rotation angle of the lever 5 is less than the locking angle, the clutch 44 can release the restriction of the shaft 46.

That is, when the door 2 is opened from a closed state and the lever 5 rotates by the operation of the reference pin 35, the clutch 44 can release the connection between the spring 43 and the shaft 46 when the rotation angle of the lever 5 is greater than the switching angle and can restrict the rotation of the shaft 46 when the lever 5 rotates further and the rotation angle of the lever 5 becomes the locking angle. Therefore, even if the door 2 is opened further, the position of the lever 5 can be fixed.

In addition, when the door (2) is closed, the reference pin 35 enters the slit 53, and the lever 5 rotates by the operations of the reference pin 35 and the lever 5, releasing the restriction. When the lever 5 rotates further and the rotation angle of the lever 5 becomes smaller than the switching angle, the clutch 44 connects the spring 43 and the shaft 46, and thus the lever 5 rotates by the torque of the spring 43, and the door 2 can be automatically closed by the operations of the lever 5 and the reference pin 35 even if no external force is applied to the door 2.

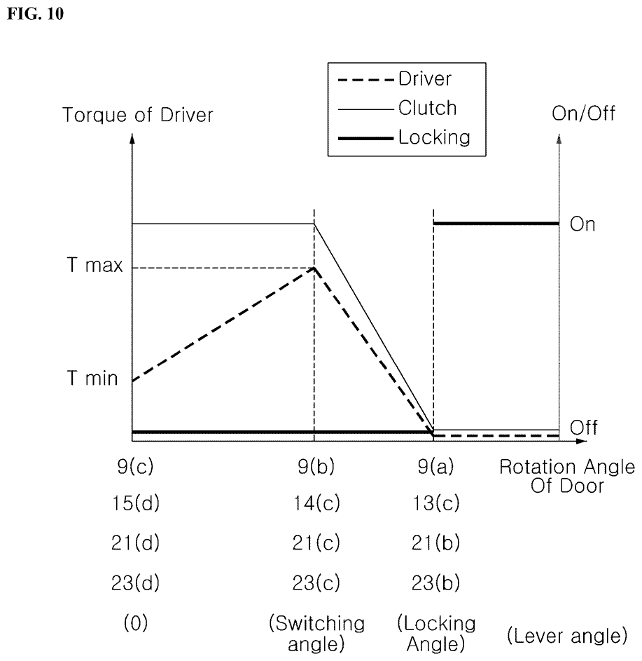

A description of the switching angle and locking angle according to embodiments of the present disclosure will be described later with reference to FIG. 10.

The clutch 44 may be coupled to the other end 434 of the spring 43. The clutch 44 may include a connector 45. The connector 45 may include a second spring coupling portion 453 coupled to the other end 434 of the spring 43.

The connector 450 may include a flange 456. The second spring coupling portion 453 may protrude upward from the flange 456.

The flange 456 may be formed in a circular shape. The flange 456 may have a width greater than that of the second spring coupling portion 453. The flange 456 may support the lower portion of the spring 43.

The connector 45 may include a latch holder 457. The latch holder 457 may protrude downward from the flange 456.

The shaft 46 may include a clutch shaft 463. The latch holder 457 may surround the clutch shaft 463. The clutch shaft 463 may be accommodated within the latch holder 457. The clutch shaft 463 may be inserted into the latch holder 457.

The latch holder 457 may include a first latch receiving portion 4571. The latch holder 457 is formed in a hollow cylindrical shape, and the first latch receiving portion 4571 is formed in a shape penetrating between the inner and outer surfaces of the cylindrical shape and may extend in the longitudinal direction.

The clutch 44 may include a latch 47. The latch 47 may be disposed in the first latch receiving portion 4571. The latch 47 may have a cylindrical shape. The diameter of the latch 47 may correspond to the width of the first latch receiving portion 4571.

A plurality of latches 47 may be provided. For example, there may be two latches 47.

The latch holder 457 may be formed in an arc shape. The first latch receiving portion 4571 may be provided at an end of the arc shape.

The latch holder 457 may be formed in a plurality of arc shapes. The first latch receiving portion 4571 may be positioned between these arc shapes.

A first latch mounting groove 4637 may be formed in the clutch shaft 463. The first latch mounting groove 4637 may be recessed inward from the outer peripheral surface of the clutch shaft 463. The width of the first latch mounting groove 4637 may be less than the diameter of the latch 47. According to the rotation of the lever 5 and/or the clutch shaft 463, the latch 47 may be engaged with or disengaged from the first latch mounting groove 4637.

When the latch 47 is removed from the first latch mounting groove 4637, the connection between the connector 45 and the shaft 46 may be released. Accordingly, the connection between the spring 43 and the shaft 46 may be released.

The clutch 44 may include a clutch housing 49. The clutch housing 49 may include a shaft receiving portion 496. The shaft receiving portion 496 may be provided within the clutch housing 49. The shaft receiving portion 496 may be formed as a hollow portion of the clutch housing 49.

The clutch shaft 463 may be disposed in the shaft receiving portion 496. The inner diameter of the shaft housing 496 may be greater than the outer diameter of the clutch shaft 463.

The latch holder 457 may be disposed between the clutch shaft 463 and the clutch housing 49.

The inner diameter of the shaft receiving portion 496 may correspond to the outer diameter of the latch holder 457. The inner diameter of the shaft receiving portion 496 may be equal to or slightly greater than the outer diameter of the latch holder 457. The latch holder 457 may be rotatably supported in the clutch housing 49.

The clutch housing 49 may include a second latch receiving portion 497. The second latch receiving portion 497 may be recessed outward from the shaft receiving portion 496.

The clutch shaft 463 may rotate according to the rotation of the lever 5. When the clutch shaft 463 rotates according to the rotation of the lever 5, and the first latch mounting groove 4637 and the second latch receiving portion 497 are aligned, the latch 47 may be accommodated in the second latch receiving portion 497.

When the latch 47 is positioned in the groove of the clutch shaft 463 and the second latch receiving portion 497, rotation of the clutch shaft 463 can be restrained with respect to the clutch housing 49 and the housing 41 by the latch 47.

The housing 41 can be fixed to the door 2. Accordingly, rotation of the lever 5 can be restrained with respect to the door 2.

The shaft 46 may include a lever shaft 465. The lever shaft 465 may rotate integrally with the clutch shaft 463. The lever shaft 465 and the clutch shaft 463 may be formed integrally.

A shaft through-hole 499 may be formed at the lower end 498 of the clutch housing 49. The shaft through-hole 499 may communicate with the shaft receiving portion 496.

The lever shaft 465 may pass through the shaft through-hole 499.

The clutch 44 may include a bearing 48. The bearing 48 may rotatably support the shaft 46.

The bearing 48 may be positioned on the upper side of the lower portion of the clutch housing 49. The lever shaft 465 may pass through the bearing 48.

The shaft 44 may include a support ring 464. The support ring 464 may protrude radially from the shaft. The portion of the shaft 44 positioned above the support ring 464 may be referred to as a latch shaft 463, and the portion positioned below the support ring 464 may be referred to as the lever shaft 465. The support ring 464 may be positioned between the latch shaft 463 and the lever shaft 465.

The support ring 464 may support the latch 47 under the latch 47. The support ring 464 may be positioned above the bearing 48 to support the shaft 44.

The lever shaft 465 may be coupled to the lever 5. The lever shaft 465 may rotate integrally with the lever 5.

The lever 5 may include a shaft insertion hole 54 into which the lever shaft 465 is inserted. The outer circumference of the lever shaft 465 may be formed non-circular. The shaft insertion hole 54 may have a shape corresponding to that of the lever shaft 465.

The lever 5 may include a rim 542 disposed around the shaft insertion hole 54. The rim 542 may protrude upward from the body of the lever 5.

A fastening hole 466 may be formed at the end of the lever shaft 465. A fastening hole 56 may also be formed in the lever 5. A fastening member may pass through the fastening hole of the lever 5 and be inserted into the fastening hole 466 of the lever shaft 465 to couple the lever 5 and the lever shaft 465.

The lever 5 may include a rim 562 disposed around the fastening hole 56. The rim 562 may protrude downward from the body of the lever 5.

When the latch 47 is positioned in the groove of the clutch shaft 463 and the second latch receiving portion 497, rotation of the lever 5 with respect to the door 2 may be restrained.

The housing 41 may include a side wall 411. The side wall 411 may be formed in an angular shape, for example, a square pillar shape.

An internal space 413 is formed inside the side wall 411 of the housing 41.

The housing 41 may include a fastening portion 415 protruding from the side wall 411. The fastening portion 415 may be provided at the lower end of the side wall 411. The fastening member 415 may be provided as a pair on both the left and right sides.

The housing 41 may be inserted into the auto-closing receiving portion 234, and the fastening portion 415 may be fastened to the lower surface of the door 2.

The lever shaft 46 may provide a rotation center for the lever 5. The lever 5 can rotate around the shaft insertion hole 54.

The lever 5 may include a finger 51 in which the slit 53 is formed. The finger 51 may extend radially outward from the rotation center of the lever 5.

The finger 51 may include a first finger 511 positioned on one side of the slit 53 and a second finger 512 positioned on the other side. The first finger 511 may be positioned forward of the slit 53, and the second finger 512 may be positioned in the rear of the slit 53.

When an external force is applied to the door 2 in a closing direction while the reference pin 35 is positioned in the slit 53, a force (reaction force) is applied to the first finger 511 by the fixed reference pin 35, and thus the lever 5 can rotate such that the finger 51 moves forward.

When the lever 5 is rotated by the auto-closing device 4 while the reference pin 35 is positioned in the slit 53, the second finger 512 pushes the reference pin 35, and since the reference pin 35 is fixed, the door 2 can rotate or move such that the auto-closing device 4 faces rearward.

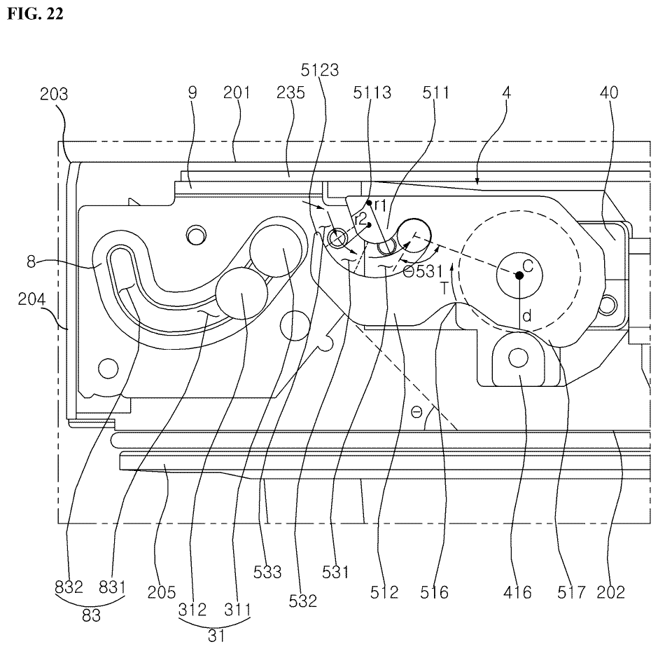

A detailed description of the structure of the lever 5 and the operations of the lever 5 and the reference pin 35 according to the first embodiment of the present disclosure will be described below with reference to FIGS. 22 to 24.

The lever 5 may include a cam 57. The cam 57 may protrude radially outside the lever 5. The cam 57 may extend from the rotation center of the lever 5 in a direction different from the direction of the finger 51. During the closing process of the door 2, the cam 57 may contact the soft closing device 7, and the soft closing device 7 may apply force to the lever 5 in the opposite direction of the rotation of the lever.

Hereinafter, a structure of a lever 61 of an auto-closing device 4A and the operations of the lever 61 and a reference pin 35 according to a second embodiment of the present disclosure will be described with reference to FIGS. 8 and 10.

Referring to FIG. 8, the lever 61 of the auto-closing device 4A according to the second embodiment of the present disclosure may be rotatably provided on the bottom surface of the door 2. The lever 61 may include a slit 613 into which the reference pin 35 is inserted. The reference pin 35 is inserted into the slit 613 of the lever 61 and can slide along the slit 613. When the door 2 rotates in a state in which the reference pin 35 is inserted into the slit 613, the lever 61 can rotate in accordance with the rotation of the door 2.

When the door 2 rotates in the opening direction do, the reference pin 35 is secured to the cabinet 10 and is positioned between a hinge shaft 32 and the rotation center C of the lever 61, allowing the lever 61 to rotate.

When the door 2 is closed, if the reference pin 35 is inserted into the slit 613, the lever 61 rotates by the torque T of the auto-closing device 4 and can apply force in the closing direction dc to the door 2.

The lever 61 can rotate in the same direction as the door 2. For example, as shown in FIG. 7, when the door 2 rotates counterclockwise when it is opened and clockwise when it is closed, the lever 61 can also rotate counterclockwise when the door is opened and clockwise when the door is closed.

The lever 61 may include fingers 611 and 612 extending radially outward from the rotation center. The slit 613 may be formed in the fingers 611 and 612.

The slit 613 may extend straight. The slit 613 may extend in a straight line.

The slit 613 may extend at an angle relative to the width direction of the door (i.e., the left-right direction). The slit 613 may be formed at an angle relative to the radial direction of the lever 61. More specifically, when the door 2 is closed, the outer side of the slit 613 is positioned rearward, and the inner side is positioned forward based on the position of the lever 61, and thus the slit 613 may extend in a direction intersecting the width direction of the door 2.

The fingers 611 and 612 may include a first finger 611 and a second finger 612. The slit 613 may be formed between these fingers.

The slit 613 may include a first region 6131 located on the inside and a second region 6132 located on the outside. The first region 6131 and the second region 6132 are positioned in a straight line, and the slit 613 may be formed to have a structure that opens outward. Accordingly, the second region 6132 may have a shape that opens toward the outer end of the lever 61.

The lever 61 may be disposed between the front surface 201 and the rear surface 202 of the door 2. When the door 2 is closed, the front end of the lever 61 may extend parallel to the front surface of the door 2 and may be positioned rearward of the front surface of the door 2. The outer rear end 6122 of the lever 61 may extend in a direction intersecting the width direction of the door 2, and thus the angle θ61 formed with respect to the width direction of the door 2 may be less than 90 degrees.

The angle θ61 may be the maximum rotation angle of the lever 61. That is, when the door 2 is fully opened and the lever 61 is rotationally restrained (refer to FIG. 8(a)), the outer rear end 6122 of the lever 61 may be disposed parallel to the rear surface 202 of the door 2. At this time, the outer rear end 6122 of the lever 61 may be positioned in front of the rear surface of the door 2 or in front of the gasket 205 provided on the door 2.

A lever stopper 416 may protrude from the lower surface of the door 2. The lever stopper 416 may be positioned at the rear of the lever 61.

The lever stopper 416 may be a component of the auto-closing device 4. Alternatively, the lever stopper 416 may be a component of the cap deco 23 or a component mounted on the cap deco 23.

The lever stopper 416 may protrude from the lower surface of the door 2 and be positioned at the same height as the lever 61.

When the door 2 is opened, the lever 61 may rotate in a direction in which the fingers 611 and 612 face rearward and contact the lever stopper 416. The lever 61 may include a first contact portion 616 that contacts the lever stopper 416 when the door 2 is opened.

The distance between the rotation center c of the lever 61 and the first contact portion 616 may be greater than the distance d between the rotation center c and the lever stopper 416. The first contact portion 616 may include a portion where the distance to the rotation center c of the lever 61 is greater than the distance d between the rotation center c and the lever stopper 416.

Therefore, the first contact portion 616 may contact the lever stopper 416 when the door 2 is opened, and the rotation of the lever 61 may be restricted.

When the door 2 is closed, the lever 61 may rotate in a direction in which the fingers 611 and 612 face forward and may contact the lever stopper 416. The lever 61 may include a second contact portion 617 that contacts the lever stopper 416 when the door 2 is closed.

The distance between the rotation center c of the lever 61 and the second contact portion 617 may be greater than the distance d between the rotation center c and the lever stopper 416. The second contact portion 617 may include a portion where the distance to the rotation center c of the lever 61 is greater than the distance d between the rotation center c and the lever stopper 416.

Accordingly, the second contact portion 617 may contact the lever stopper 416 when the door 2 is closed, and the rotation of the lever 61 can be restricted.

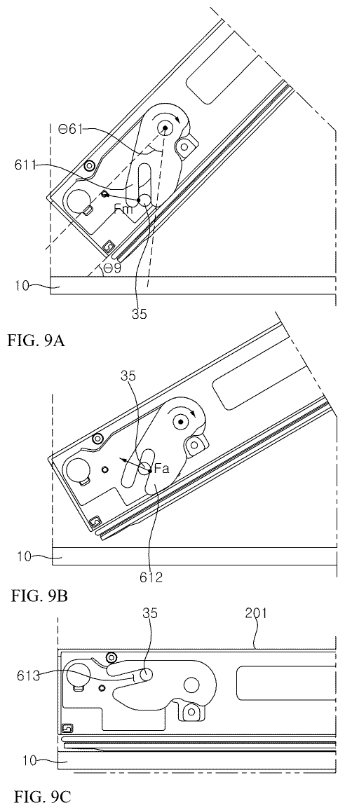

Meanwhile, the refrigerator of the second embodiment illustrated in FIGS. 9A to 9C may have the same structure as the hinge 3 and the guide member 8 of the first embodiment illustrated in FIG. 4, or a different structure. For example, unlike the first embodiment, the refrigerator of the second embodiment has the hinge shaft 32 formed as a single shaft to provide a fixed rotation center to the door 2, and the door 2 can rotate around the fixed rotation center to open and close the storage compartment 11.

Referring to FIGS. 8 to 10, the driver 40 may rotate the lever 61 such that the door 2 is closed by the operations of the lever 61 and the reference pin 35.

The reference pin 35 may be positioned between the hinge shaft 32 and the rotation center c of the lever 61 in the width direction of the door 2. When the reference pin 35 is positioned in the slit 613, the reference pin 35 may be disposed between the hinge shaft 32 and the rotation center c of the lever 61 in the width direction of the door 2.

FIGS. 9A and 9B illustrate states in which the reference pin is positioned along the dotted lines 9A and 9B in FIG. 8. FIG. 10 illustrates the rotation of the lever 5, the torque of the driver 40, and the connection and restraint of the clutch 44 according to opening of the door 2.

When the door 2 is in the state of FIG. 9A or is more open than FIG. 9A, the clutch 44 may restrain rotation of the shaft 46. Therefore, the lever 61 does not automatically rotate relative to the door 2. That is, the rotation angle of the lever 61 in FIG. 9A is the locking angle at which the clutch 44 restrains rotation of the shaft 46.

In the state of FIG. 9A, the clutch 44 restrains rotation of the shaft 46, and connection between the spring 43 and the shaft 46 is released. Therefore, the torque of the spring 43 may not be transmitted to the lever 5.

In the state of FIG. 9A, the rotation angle θ61 of the lever 61 may be less than the rotation angle θ9 of the door 2. For example, the rotation angle θ61 of the lever 61 may be a specific angle between 30 and 35 degrees, and the opening angle θ9 of the door may be a specific angle between 40 and 50 degrees.

When an external force is applied to the door 2 in the closing direction, the lever 61 rotates relative to the door 2 such that the fingers 611 and 612 face forward due to the reaction force Fm acting on the first finger 611 from the reference pin 35.

Meanwhile, since the lever 61 is mounted on the door 2, and the rotation center c of the lever is at a fixed position on the door 2, the distance between the center c of the lever 61 and the reference pin 35 changes when the door 2 rotates. Therefore, when the door 2 rotates, the reference pin 35 slides in the slit 613. Here, sliding of the reference pin 35 means that the reference pin 35 is fixed and the slit 613 moves.

When the door 2 is closed in the state of FIG. 9A, the lever 61 can rotate in a direction in which the rotation angle θ61 decreases. When the lever 61 rotates and the rotation angle θ61 of the lever 61 becomes smaller than the locking angle, the clutch 44 can release the restraint of the shaft 46. In addition, as the lever 61 and the shaft 46 rotate, the clutch 44 can gradually connect the spring 43 and the shaft 46. As the clutch 44 connects the spring 43 and the shaft 46, the torque applied to the lever 61 from the driver 40 can increase as the rotation angle of the lever 61 decreases.

When the door 2 is closed and reaches the state of FIG. 9B, connection of the spring 43 and the shaft 46 by the clutch 44 is completed, and the torque of the spring 43 can be fully transmitted to the shaft 46. In FIG. 9B, the rotation angle θ61 of the lever 61 corresponds to a switching angle at which the clutch 44 connects the spring 43 and the shaft 46.

In the state of FIG. 9B, the rotation angle θ61 of the lever 61 may be less than or equal to the rotation angle θ9 of the door 2. For example, the rotation angle θ61 of the door 2 and the lever 61 may be a specific angle between 25 degrees and 30 degrees.

When the lever 61 rotates to reach the state of FIG. 9B, the clutch 44 connects the spring 43 and the shaft 46, and in this state, the torque T of the spring 43 is transmitted to the lever 61, and thus the lever 61 rotates. The spring 43 of the driver 40 provides torque to the lever 61 such that the lever 61 rotates in the direction in which the finger 61 faces forward. As the lever 61 rotates, the torque of the spring 43 decreases.

When the lever 61 rotates such that the finger 61 faces forward (clockwise in FIG. 8), the lever 61 applies a force Fa forward to the reference pin 35. Since the position of the reference pin 35 is fixed and the door 2 can rotate around the hinge shaft 32, the rotation center c of the lever 61 can move in the direction in which the lever 61 rotates relative to the reference pin 35. That is, the rotation center c can move rearward. Since the door 2 is provided with a rotation center by the hinge shaft 32, the door 2 can rotate such that the rotation center c of the lever 61 faces rearward.

Therefore, the door 2 can be closed through the force applied by the auto-closing device 4 to rotate the lever 61.

As the lever 61 rotates such that the finger 61 faces forward, the torque of the spring 43 decreases.

As shown in FIG. 9C, when the door 2 is closed, the reference pin 35 can contact the inner end of the slit 613.

When the door 2 is closed as shown in FIG. 9C, the second contact portion 617 can contact the stopper.

The door 2 may be opened in the order of (C), (B), and (A) of FIG. 9 (excluding the force and direction indicated by the arrows). When the door 2 is opened, the rotation center c of the lever 61 moves forward, and since the reference pin 35 is fixed, the lever 61 rotates such that the fingers 611 and 612 face rearward.

If the door 2 is further opened beyond the state of FIG. 9A, the first contact portion 616 contacts the lever stopper 416, preventing the lever 61 from further rotating. The reference pin 35 can then be released from the slit 613.

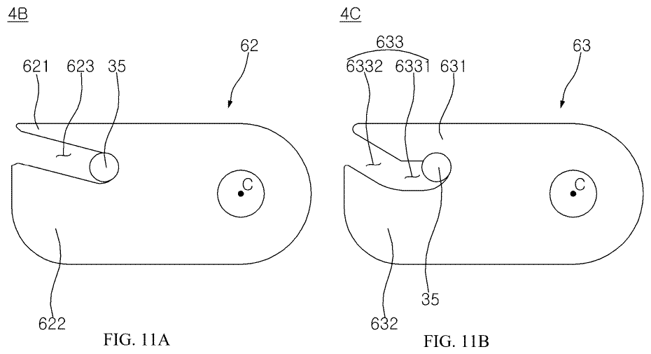

Hereinafter, levers 62 and 63 of auto-closing devices 4B and 4C according to third and fourth embodiments of the present disclosure will be described with reference to FIGS. 11A and 11B.

The lever 62 according to the third embodiment may include a slit 623 into which a reference pin 35 is inserted. The outer end of the slit 623 may be positioned forward relative to the inner end. The outer end and inner end may refer to the outer end and inner end in the rotational radial direction of the lever 62. That is, the end closer to the rotation center c of the lever 62 may be referred to as the inner end, and the end farther away therefrom may be referred to as the outer end. In the description of other embodiments, the inner end and outer end of the slit may also refer to the outer end and inner end in the rotational radial direction of the lever.

The lever 62 according to the third embodiment illustrated in FIG. 11A differs from the lever 61 according to the first embodiment described above with reference to FIG. 8 in that the outer end of the slit 623 is positioned forward relative to the inner end, and may have all the other features of the lever 61 according to the first embodiment.

The lever 62 according to the third embodiment has the slit 623 formed between a first finger 621 and a second finger 622, and the slit 623 may be a straight line connecting the outer end and the inner end.

The positions of the outer end and the inner end of a slit 633 of the fourth embodiment may be the same as the positions of the outer end and the inner end of the slit 623 of the third embodiment. The outer end of the slit 633 may be positioned forward relative to the inner end.

In addition, the clutch 44 of the auto-closing device 4B according to the third embodiment and the clutch 44 of the auto-closing device 4C according to the fourth embodiment may have the same locking angle. In addition, the clutches 44 according to the third and fourth embodiments may have a locking angle greater than the locking angle of the clutches 44 of the first and second embodiments described above. For example, the locking angle of the clutches 44 of the first and second embodiments may be an angle selected in the range of 25 degrees to 35 degrees, and the locking angle of the clutches 44 of the third and fourth embodiments may be an angle selected in the range of 35 degrees to 45 degrees.

The lever 63 according to the fourth embodiment illustrated in FIG. 11B differs from the lever 62 according to the third embodiment in that the slit 633 has a bent shape. The lever 63 according to the fourth embodiment includes the slit 633 formed between a first finger 631 and a second finger 632, and the slit 633 may include a first region 6331 extending from the inner end and a second region 6332 extending from the outer end.

The first region 6331 and the second region 6332 may each have an arc shape convex rearward, and may have different radii of curvature. For example, the radius of curvature of the first region 6331 may be greater than that of the second region 6332.

Accordingly, in the auto-closing device 4C according to the fourth embodiment, the lever 63 relatively more rotates when the reference pin 35 passes through the second region 6332 of the slit 633 and relatively less rotates when the reference pin 35 passes through the first region 6331, compared to the auto-closing device 4B according to the third embodiment. Therefore, the clutch 44 is rapidly engaged during the closing process of the door 2, and the door 2 can be smoothly closed by the auto-closing device 4C.

Hereinafter, a structure of a lever 64 of an auto-closing device 4D and the operations of the lever 64 and the reference pin 35 according to a fifth embodiment of the present disclosure will be described with reference to FIGS. 12 to 15.

Referring to FIG. 12, the door 2 of the refrigerator according to an embodiment of the present disclosure may be rotatably provided at the front of the cabinet 10, and the position of the rotation center of the door 2 may vary depending on the degree of door opening.

The shaft insertion groove 83 of the guide member 8 may have a structure extending with a constant width. For example, the shaft insertion groove 83 may extend in a curved shape. For example, the shaft insertion groove 83 may have an arc shape. For example, the shaft insertion groove 83 may have a shape formed by connecting two arcs having different radii of curvature.

The shaft insertion groove 83 may include a first curved part 831 where the hinge shaft 31 is positioned when the door 2 is closed, and a second curved part 832 where the hinge shaft 31 is positioned when the door 2 is open. The second curved part 832 may be positioned relatively close to the outer end of the door 2, and the first curved part 831 may be positioned relatively far from the outer end of the door 2.

The first and second curved parts 831 and 832 may be connected. The first curved part 831 may extend rearward toward the second curved part 832, and the second curved part 832 may extend rearward toward the first curved part 831. The shaft insertion groove 83 may have a shape that is convex rearward.

The radius of curvature of the second curved part 832 may be smaller than the radius of curvature of the first curved part 831.

The shaft insertion groove 83 movably supports the hinge shaft 31. The door can be opened and closed as the hinge shaft 31 rotates and/or moves within the guide member.

The width of the shaft insertion groove 83 may correspond to the outer diameter of the hinge shaft 31. That is, the width of the shaft insertion groove 83 may be equal to or slightly greater than the outer diameter of the hinge shaft 31 such that the hinge shaft 31 can slide along the shaft insertion groove 83.

Two or more hinge shafts 31 may be provided. For example, the hinge 3 may include two hinge shafts 311 and 312. Hereinafter, among the two hinge shafts 311 and 312, the hinge shaft 311 located relatively inside in the width direction of the door 2 is referred to as a first hinge shaft 311, and the hinge shaft 312 located outside is referred to as a second hinge shaft 312. That is, the first hinge shaft 311 may be disposed relatively close to the front end of the first curved part 831 when the door 2 is closed, and the second hinge shaft 312 may be disposed relatively close to the front end of the second curved part 832 when the door 2 is open.

The door 2 may be provided with a rotation center by the first and second hinge shafts 311 and 312. Here, the position of the rotation center of the door 2 may change depending on the degree of door opening as described above. That is, when the door 2 is opened, the two hinge shafts 31 slide along the shaft insertion groove 83 within the shaft insertion groove 83, and thus the door 2 can rotate.

When the position of the rotation axis of the door 2 is fixed as in the second embodiment, the front outer edge 203 of the door 2 may deviate from the position of the outer end 204 in the width direction of the door 2 when the door 2 is closed as the door is opened (refer to FIGS. 9A to 9C).

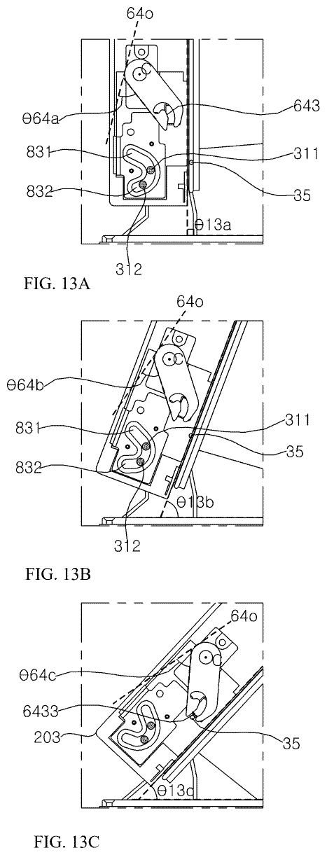

The hinge shaft 31 and shaft insertion groove 83 of the present embodiment ensure that the front outer edge 203 of the door 2 does not deviate from the position of the outer end 204 of the door 2 when the door 2 is closed even when the door 2 is opened, or minimize the extent of such deviation (refer to FIGS. 13A to 13C to 15).

Therefore, in situations where other furniture is placed next to the refrigerator, or the refrigerator is placed in a storage unit and the refrigerator door does not protrude forward relative to the other furniture or storage unit, the door can be opened without interfering with the other furniture or storage unit.

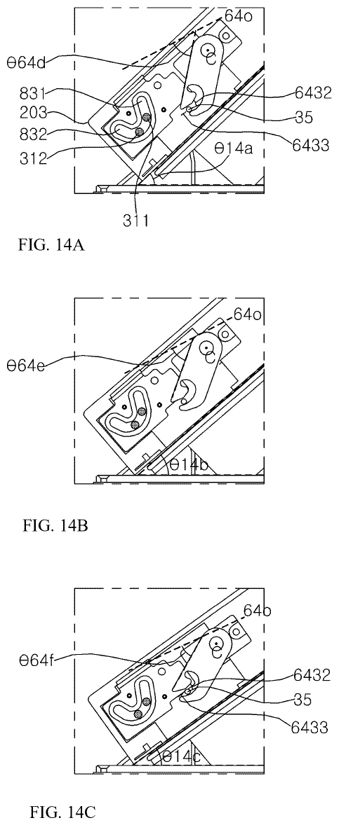

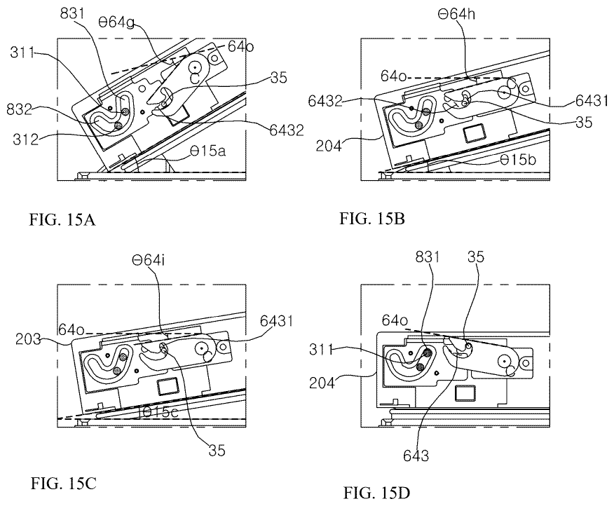

FIGS. 13A to 13C to 15 illustrate a state in which the opening angle of the door 2 gradually decreases in the order of (A), (B), and (C) of FIG. 13, (A), (B), and (C) of FIG. 14, and (A), (B), (C), and (D) of FIG. 15.

The door 2 can be opened further than in FIG. 13(a). For example, the door opening angle θ13a in FIG. 13(a) is 90 degrees, and the maximum opening angle of the door 2 may be greater than 90 degrees. When the door 2 is opened to the maximum, the second hinge shaft 312 may be in contact with the front end of the second curved part 832 or may be slightly separated therefrom.

Referring to FIG. 13(a), when the door 2 is opened 90 degrees, the first hinge shaft 311 can be located at the boundary between the second curved part 832 and the first curved part 831. Therefore, when the door 2 is opened more than 90 degrees, the first and second hinge shafts 311 and 312 can slide along the second curved part 832 (the first and second hinge shafts 311 and 312 are fixed and the guide member 8 moves). Therefore, the door 2 can be opened by coming forward. Therefore, when the door 2 is opened to the maximum, interference with other furniture or appliances placed on the side of the refrigerator 1 can be minimized.

FIG. 13B to FIG. 14C illustrate a state in which the first hinge shaft 311 is positioned at the first curved part 831 and the second hinge shaft 312 is positioned at the second curved part 832.

In the process of opening the door 2 in the order of FIG. 14C and FIG. 13B, the second hinge shaft 312 moves relatively along the second curved part 832, and thus the widthwise outer side 204 and the front edge 203 of the door 2 move inwardly in the width direction of the cabinet 10 as the door 2 opens, compared to when the rotation center is fixed. Accordingly, the widthwise outer side 204 and the front edge 203 of the door 2 do not deviate from the outer edge of the door when the door is closed, or if they do, they deviate to a minimum.

FIG. 15A shows a state in which the second hinge shaft 312 is positioned at the boundary between the first curved part 831 and the second curved part 832, and the first hinge shaft 311 is positioned at the first curved part 831, and FIG. 15D shows a state in which the door 2 is closed. When the door 2 is closed, the first hinge shaft 311 may be positioned at the front end of the first curved part 831.

When the door 2 is opened while passing through the states of FIG. 15C and FIG. 15B to reach the state of FIG. 15A, the first and second hinge shafts 311 and 312 move relatively rearward along the first curved part 831, and thus the outer surface of the door 2 can move inwardly in the width direction as a whole while rotating such that the front end faces rearward. Accordingly, even in this process, the widthwise outer side 204 and the front edge 203 of the door 2 do not deviate from the outer edge of the door when the door is closed, or if they do, they can deviate the outer edge to a minimum.

Referring to FIG. 12, the auto-closing device 40 of the present disclosure includes the same driver 40 as the driver 40 of the aforementioned embodiments, and the structure of a lever 64 may be different from the levers 5, 61, 62, and 63 of the aforementioned embodiments.

The lever 64 may be rotatably coupled to the driver 40. The driver 40 may provide a rotation center c and torque to the lever 64. The lever 64 includes fingers 641 and 642 extending radially outward from the rotation center c, and a slit 643 may be formed in the fingers 641 and 642. The fingers 641 and 642 may include a first finger 641 positioned forward of the slit 643 and a second finger 642 positioned in the rear of the slit 643.

The slit 643 may have an arc shape. The slit 643 may have a curved shape that is convex toward the rear.

The slit 643 may include a first region 6431 that forms an inner end of the slit 643 close to the rotation center c. he first region 6431 may extend rearward from the inner end of the slit 643.

The first region 641 may be arc-shaped. The first region 6431 may have an arc shape with a center of curvature positioned forward. In other words, the first region 6431 may be arc-shaped and convex rearward.

The first region 6431 may include a portion that extends forward and backward. The first region 6431 may include a portion that extends forward and backward when the door 2 is closed. The portion that extends forward and backward may extend rearward from the inner end.

The reference pin 35 may be inserted into the slit 643. When the door 2 is closed, the reference pin 35 can be positioned at the inner end of the slit 643.

As described above, the first region 6431 includes a portion extending rearward from the inner end, and when the door 2 is closed, a first reference pin 351 can be positioned at the inner end. Accordingly, when the door 2 is opened from a closed state, the first reference pin 351 slides along the first region 6531, but the first reference pin 351 may not press the lever 64.

Accordingly, when the door 2 is opened, the lever 64 may not rotate, and in this case, the user can open the door 2 with relatively little force.

The slit 643 may include a second region 6432 extending radially outward from the first region 6431.

The second region 6432 may have an arc shape. The second region 6432 may have an arc shape with a center of curvature positioned forward. In other words, the second region 6432 may have a shape that is convex rearward. The second region 6432 may extend forward with increasing distance from the first region 6431.

The slit 643 may include a third region 6433. The third region 6433 extends from the second region 6432 and may extend to the outer end of the slit 643 in the direction of the rotational radius of the lever 64. The third region 6433 may extend continuously from the second region 6432 or may be bent from the second region 6432. The third region 6433 may extend in a forward direction with increasing distance from the second region 6432.

The driver 40 may be disposed between the front surface 201 and the rear surface 202 of the door 2. The rotation center c of the lever 64 may also be disposed between the front surface 201 and the rear surface 202 of the door 2. When the door 2 is closed, the lever 64 may be disposed to be inclined with respect to the width direction of the door 2 such that the fingers 641 and 642 are positioned forward of the rotation center c.

In FIGS. 13A to 13C to 15, the rotation angle of the lever 64 may refer to the angle between the rotational position of the lever 64 when the door 2 is closed and the rotational position of the lever 64 at a specific point in time. For example, the angle between the front end of the first finger 641 and a straight line 640 parallel to the front end of the first finger 641 in each of the states of FIGS. 13A to 13C to 15 may be referred to as the rotation angle of the lever 64.

Referring to FIGS. 10 and 13, when the door 2 is opened and the reference pin 35 is out of the slit 643, the shaft 46 can be restrained by the clutch 44 without being rotated. Therefore, even if the door 2 rotates, the lever 64 may not rotate with respect to the door 2 when the reference pin 35 is out of the slit 643. Therefore, the rotation angle θ64a of the lever 64 in FIG. 13(a) and the rotation angle θ64b of the lever 64 in FIG. 13(b) may be the same.

FIG. 13(c) shows a state in which the reference pin 35 enters the third region 6433 of the slit 643. When the door 2 is closed and the reference pin 35 enters the third region 6433 of the slit 643, and then the door 2 is further closed, the lever 64 is rotated by the reference pin 35 in the direction in which the fingers 641 and 642 move forward, and the clutch 44 can release the restraint of the shaft 46. Therefore, the rotation angle θ64c of the lever 64 in FIG. 13(c) may be referred to as a locking angle. In the present embodiment, the locking angle θ64c of the lever 64 may be a specific angle within the range of 45 degrees to 55 degrees. The rotation angles θ64a and 064b of the lever 64 in FIGS. 13A and 13B may be equal to the locking angle.

When the reference pin 35 is positioned within the slit 643, the rotation angle of the lever may vary depending on the rotation angle of the door 2. For example, the rotation angle of the lever 64 may be proportional to the rotation angle of the door 2. In the present embodiment, the rotation angle of the lever 64 may be equal to the rotation angle of the door 2.

Referring to FIGS. 10 and 14A to 14C, as the door 2 closes, the reference pin 35 may slide relatively along the third region 6433 of the slit 643. As the reference pin 35 slides along the third region 6433, the lever 64 and the shaft 46 rotate, and accordingly, the clutch 44 can connect the spring 43 and the shaft 46.

FIG. 14C shows a state in which the rotation angle θ64f of the lever 64 is the switching angle, and the reference pin 35 can be located at the boundary between the third region 6433 and the second region 6432. In the present embodiment, the switching angle may be within the range of 25 to 35 degrees.

Referring to FIGS. 10 and 15, if the rotation angle θ64 of the lever 64 is less than the switching angle, the torque of the driver 40 can be proportional to the rotation angle θ64 of the lever 64.

FIG. 15A shows a state in which the reference pin 35 is positioned in the second region 6432, and FIG. 15B shows a state in which the reference pin 35 is positioned at the boundary between the second region 6432 and the first region 6431. When the reference pin 35 is positioned at the boundary between the first and second regions 6431 and 6432, the rotation angle of the lever may be within the range of 10 to 20 degrees.

FIG. 15C shows a state in which the reference pin 35 is positioned in the first region 6432, and FIG. 15D shows a state in which the door 2 is closed. When the door 2 is closed, the reference pin 35 may contact the inner end of the slit 643.

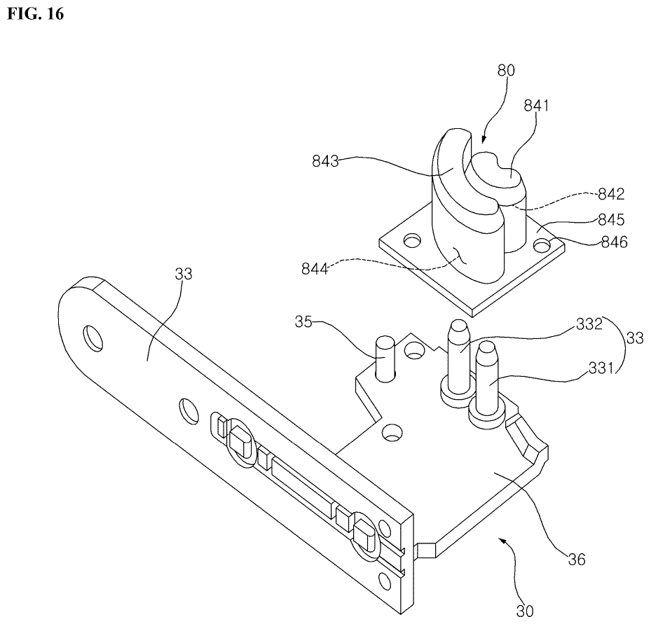

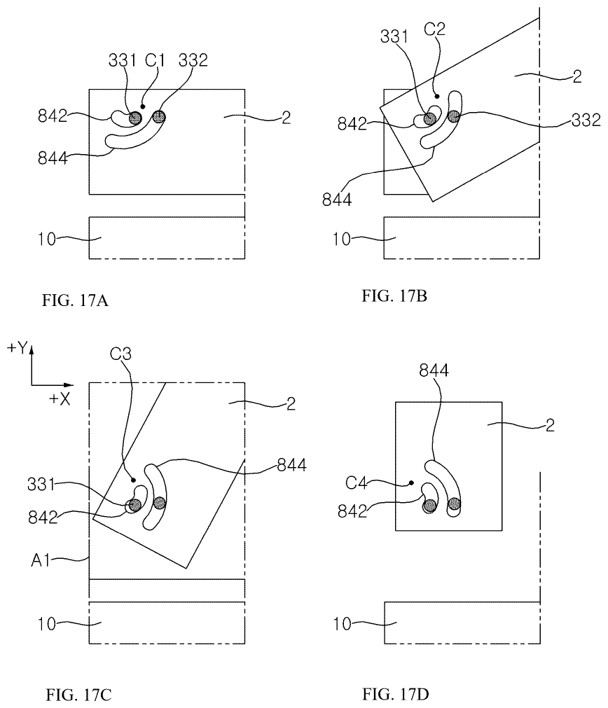

Hereinafter, a hinge 30 and a guide member 80 according to another embodiment of the present disclosure will be described with reference to FIGS. 16 and 17. The hinge 30 of the present embodiment can be applied to all other embodiments of the present disclosure, i.e., home appliances of the first to eighth embodiments.

The hinge 30 of the present embodiment may include a coupling portion 33, a support 36, and a reference pin 35, similar to the hinge 3 of the aforementioned embodiments. Furthermore, the hinge 30 of the present embodiment may include two hinge shafts 33, similar to the hinge 3 of the aforementioned embodiments. The hinge shafts 33 may include a first hinge shaft 331 positioned on the outer side of the cabinet 10 in the width direction, and a second hinge shaft 332 positioned on the inner side.

The guide member 80 of the present embodiment may include a first shaft receiving portion 841 and a second shaft receiving portion 843. A first shaft receiving groove 842 into which the first hinge shaft 331 is inserted may be formed in the first shaft receiving portion 841, and a second shaft receiving groove 844 into which the second hinge shaft 332 is inserted may be formed in the second shaft receiving portion 843.

The guide member 80 may include a guide base 845. A fastening hole 846 may be formed in the guide base 845, and the guide base 845 may be coupled to the lower surface of the door 2, i.e., the cap deco 23, through a fastening member.

The first and second shaft receiving portions 841 and 843 may protrude upward from the guide base 845, and the first and second shaft receiving grooves 842 and 844 may be opened downward.

As the door 2 opens, the first hinge shaft 331 can move relatively along the first shaft receiving groove 842, and the second hinge shaft 332 can move relatively along the second shaft receiving groove 844. Accordingly, the door 2 can rotate with respect to the cabinet 10 while the rotation center thereof moves.

FIG. 17A shows the door 2 in a closed state. In the closed state of the door 2, the first hinge shaft 331 can be positioned at the inner end of the first shaft receiving groove 842, and the second hinge shaft 332 can be positioned at the inner end 8441 of the second shaft receiving groove 844. When the door 2 starts to open from the closed state, the door 2 can rotate around an imaginary first rotation center C1.

The first rotation center C1 may be located forward of the first and second hinge shafts 331 and 332. The first rotation center C1 may be located between the first and second hinge shafts 331 and 332 in the width direction of the cabinet 10.

FIG. 17B illustrates a state in which the door 2 has rotated by a first angle relative to the cabinet 10. For example, the first angle may be greater than 0 degrees and equal to or less than 45 degrees.

In a state in which the door 2 has rotated by the first angle, the door 2 may rotate around an imaginary second rotation center C2. The second rotation center C2 may be located at a different location from the first rotation center C1. That is, the location of the rotation center may change as the door 2 rotates.

The second rotation center C2 may be located forward of the first rotation center C1. The second rotation center C2 may be located further outward than the first rotation center C1 in the width direction of the cabinet 10.

The second rotation center C2 may be located forward of the first and second rotation shafts 331 and 332. The second rotation center C2 may be located between the first and second hinge shafts 331 and 332 in the width direction of the cabinet 10.

FIG. 17C illustrates a state in which the door 2 has rotated by a second angle, that is, by more than the first angle. For example, the second angle may be greater than 45 degrees and less than 90 degrees.

In a state in which the door 2 has rotated by the second angle, the door 2 may rotate around an imaginary third rotation center C3. The third rotation center C3 may be located at a different location from the first and second rotation centers C1 and C2.

The third rotation center C3 may be located forward of the second rotation center C2. The third rotation center C3 may be located further outward than the second rotation center C2 in the width direction of the cabinet 10.

The third rotation center C3 may be located forward of the first and second rotation shafts 331 and 332. The third rotation center C3 may be located at a position corresponding to the first hinge shaft 331 in the width direction of the cabinet 10. That is, the third rotation center C3 and the first rotation shaft 331 may overlap in the forward-backward direction.

FIG. 17D illustrates a state in which the door 2 has rotated 90 degrees, exceeding the second angle.

In a state in which the door 2 has rotated 90 degrees, the door 2 may rotate around an imaginary fourth rotation center C4. The fourth rotation center C4 may be located at a different location from the first, second, and third rotation centers C1, C2, and C3.

The fourth rotation center C4 may be located rearward of the third rotation center C3. The fourth rotation center C4 may be located further outward than the third rotation center C3 in the width direction of the cabinet 10.

The fourth rotation center C4 may be located forward of the first and second rotation shafts 331 and 332. The fourth rotation center C4 may be located further outward than the first hinge shaft 331 in the width direction of the cabinet 10.

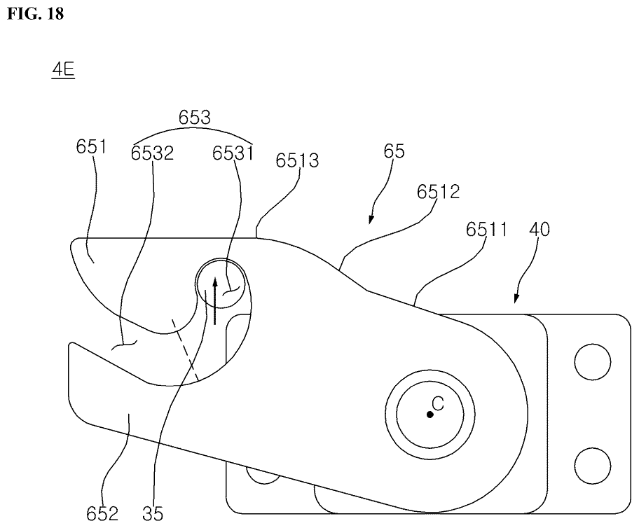

Hereinafter, a lever 65 and a hinge 3 of a home appliance according to a sixth embodiment of the present disclosure will be described with reference to FIG. 18. A driver 4 of an auto-closing device 4E of the present embodiment is the same as that of the aforementioned embodiments, and the hinge 3 may be the same as the hinge 3 of the first to fifth embodiments described above. Hereinafter, the structure of the lever 65 and the operations of the lever 65 and the reference pin 35 of the present embodiment will be described.

Referring to FIG. 18, the lever 65 may be configured to rotate about a rotation center C. The lever 65 may extend radially from the rotation center C.

The lever 65 may include fingers 651 and 652 and a slit 653. The fingers 651 and 652 may include a first finger 651 positioned forward and a second finger 652 positioned rearward. The slit 653 may be provided between the first finger 651 and the second finger 652.

The lever 65 of the present embodiment may differ from the lever 64 of the fifth embodiment described above with reference to FIGS. 12 to 15 with respect to the shape of the first finger 651. In particular, the front end of the first finger 651 may include a first portion 6511 extending parallel to the rotational radius of the lever 65, a third portion 6513 forming the outer end of the first finger 651 and extending at an angle relative to the first portion 6511, and a second portion 6512 connecting the first and third portions.

The third portion 6513 may be disposed parallel to the front surface 201 of the door 2 when the door 2 is closed. Furthermore, the third portion 6513 may be positioned rearward relative to the front surface 201 of the door 2. Accordingly, even if the lever 65 is long, the third portion 6513 may not protrude forward relative to the front surface of the door 2.

The reference pin 35 may be inserted into the slit 653. The slit 653 may have an arc shape.

The slit 653 may include a first region 6531 extending from the inner end, and a second region 6532 extending radially outward from the first region 6531.

The second region 6532 may extend to the outer end. The second region 6532 may have an arc shape. The second region 6532 may have an arc shape with a center of curvature positioned forward. That is, the second region 6532 may have a shape that is convex rearward.

Meanwhile, the first region 6531 of the present embodiment may have the same shape as the first region 6431 of the fifth embodiment described above. Furthermore, other parts of the slit 653 of the present embodiment may have the same shapes as those of the slit 643 of the fifth embodiment described above. That is, the second region 6532 may be the same as the second region 6432 of the fifth embodiment, and a third region may be further provided on the outside of the second region 6532.

The first region 6531 may extend from the second region 6532 to the inner end. The first region 6531 may have an arc shape. The first region 6531 may have an arc shape with a center of curvature positioned forward. That is, the first region 6531 may have an arc shape that is convex rearward.

The first region 6531 may include a portion extending in the forward-backward direction. The first region 6531 may include a portion extending in the forward-backward direction in a state in which the door 2 is closed. The portion extending in the forward-backward direction may extend rearward from the inner end.

During the process of closing the door 2, the reference pin 35 enters the slit 653 and slides along the second region 6532, thereby pressing the lever 65 to release restraint of the shaft 46 by the clutch 44. When the reference pin 35 slides along the first region 6531, the lever 65 may press the reference pin 35 to close the door 2, and the reference pin 35 may be positioned at the inner end of the slit 653 in a state in which the door 2 is closed.

The first region 6531 includes a portion extending rearward from the inner end, and the reference pin 35 may be positioned at the inner end when the door 2 is closed. Therefore, when the door 2 is opened from a closed state, the reference pin 35 slides along the first region 6531, but the first reference pin 351 may not press the lever 65.

Therefore, the lever 65 may not rotate when the door 2 is opened, and in this case, the user can open the door 2 with relatively little force.

During the process of closing the door 2, if the door closes quickly immediately before closing, the impact may be significant, and the door may be reopened due to the reaction force. As described above, embodiments of the present disclosure can control the closing speed of the door 2 through the soft closing device 7.

Additionally, in the present embodiment, the reference pin 35 passes through the portion of the first region 6531 extending in the forward-backward direction immediately before the door 2 closes, and the torque T of the auto-closing device 4 may not act on the reference pin 35.

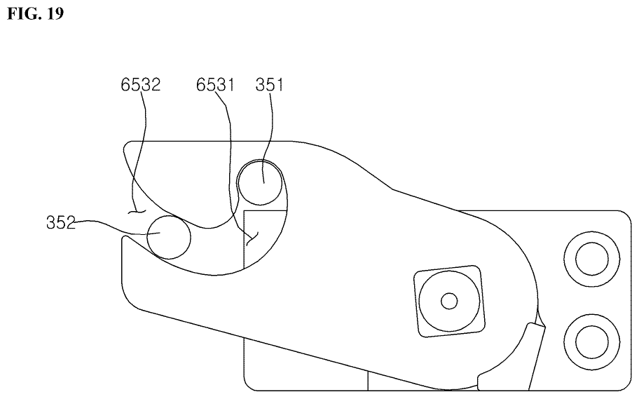

Hereinafter, the operations of the lever 65 and reference pin 35 of the home appliance according to a seventh embodiment of the present disclosure will be described with reference to FIG. 19.

An auto-closing device 4E of the present embodiment has the same structure as the auto-closing device 4E according to the sixth embodiment described above with reference to FIG. 18. Therefore, the first region 6531 may include a portion extending in the forward-backward. While this has the aforementioned advantages, there is a risk that the rotational position of the lever 65 due to rotation of the door 2 may deviate from the design standard when the reference pin 35 passes through the first region 6531.

Meanwhile, the first region 6531 may include a portion extending in a tangential direction with respect to the rotational direction of the lever 65. When the first reference pin 351 slides along the portion extending in the tangential direction, no force may be applied between the first reference pin 351 and the lever 65.

Referring to FIG. 19, the reference pin 35 may include the first reference pin 351. The first reference pin 351 may be the same as the reference pin 35 of the aforementioned embodiment.

The reference pin 35 may further include a second reference pin 352 in addition to the first reference pin 351. The second reference pin 352 may be spaced apart from the first reference pin 351. The second reference pin 352 may be disposed at a position where the second reference pin 352 enters the slit 653 later than the first reference pin 351 during the closing process of the door 2.

The second reference pin 352 may be positioned in the second region 6532 when the first reference pin 351 is positioned in the first region 6531.

This prevents the rotational position of the lever 65 due to the rotation of the door 2 from deviating from the design standard.

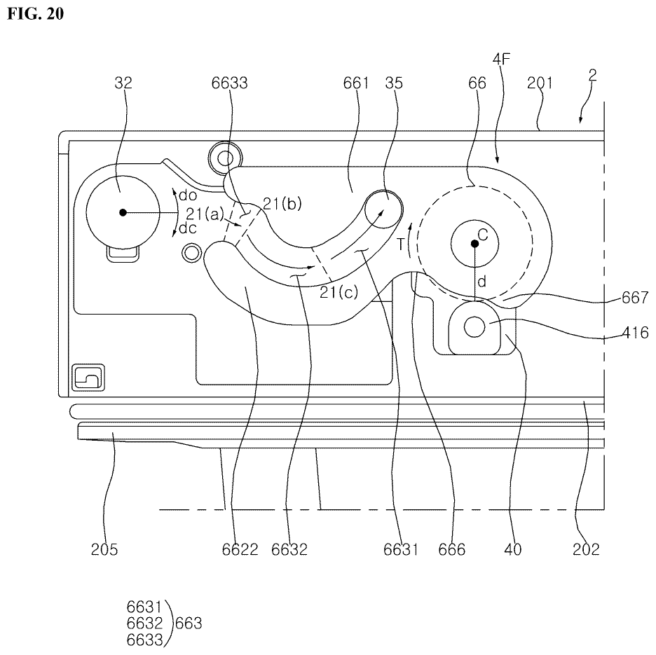

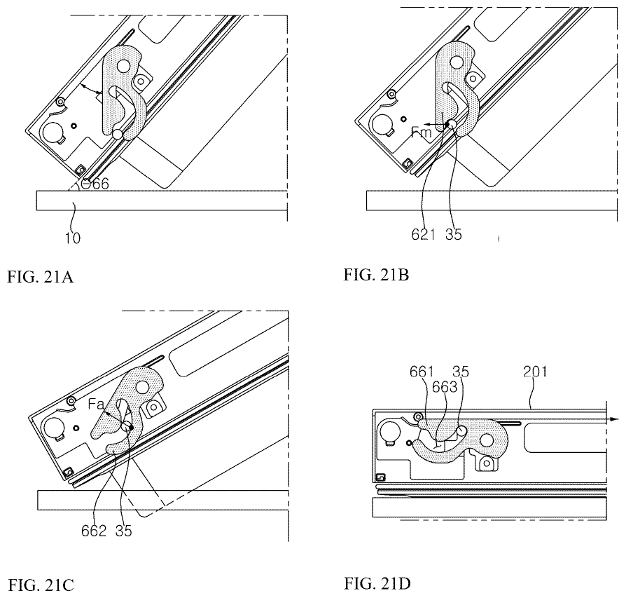

Hereinafter, a structure and operation of a lever 66 of an auto-closing device 4F according to an eighth embodiment of the present disclosure will be described with reference to FIGS. 20 and 21. In the present embodiment, an example in which the hinge 3 has a single hinge shaft 32 as in the second embodiment described above with reference to FIG. 8 will be described, but the hinges 3 having different structures described above may also be applied.

Referring to FIG. 20, the lever 66 of the refrigerator according to the eighth embodiment of the present disclosure may be rotatably provided on the bottom surface of the door 2. The lever 66 may include a slit 663 into which a reference pin 35 is inserted. The reference pin 35 may be secured to the cabinet 10, and the lever 66 may be provided on the door 2. The reference pin 35 may be inserted into the slit 663 of the lever 66 and slide along the slit 663. When the door 2 rotates while the reference pin 35 is inserted into the slit 663, the lever 66 can rotate according to the rotation of the door 2. The rotation angle of the lever 66 may be greater than the rotation angle of the door 2.

Unlike the lever 61 of the second embodiment described above with reference to FIGS. 8 and 9, the lever 66 of the present embodiment includes the slit 663 having a bent shape. For example, the slit 663 may have a bent straight shape or a curved shape.

The slit 663 may include a first region 6631 extending outward from the inner end of the slit 663, and a second region 6632 extending outward from the first region 6631.

The first region 6631 may be positioned at the inner end of the slit 663 and may extend rearward with decreasing distance to the outside. The second region 6632 may extend from the first region 6631 and may be formed to face forward with decreasing distance to the outside.

The first region 6631 may extend in a curved shape. The center of curvature of the first region 6631 may be located in the front of the slit 663. The second region 6632 may extend in a curved shape. The center of curvature of the second region 6632 may be located in the front of the slit 663. The radius of curvature of the first region 6631 may be greater than the radius of curvature of the second region 6632. This is the same as the first and second regions 531 and 532 of the slit 53 according to the first embodiment illustrated in FIG. 22, and detailed description thereof will be described later.

The slit 663 may include a third region 6633. The third region 6633 may extend from the second region 6632 and may be located at the outermost end of the slit 663. The third region 6633 may be bent from the second region 6632. For example, the second region 6632 may extend outwardly and forward, and the third region 6633 may extend radially.

The lever 66 may include fingers 661 and 662 extending radially outward from the rotation center. The slit 663 may be formed in the fingers 661 and 662.

The fingers may include first and second fingers 661 and 662. The first finger 661 may be positioned forward of the slit 663, and the second finger 662 may be positioned rearward of the slit 6632.

When the door 2 is closed, the front end of the lever 66 (or the front end of the first finger 661) may extend parallel to the front surface of the door 2 and may be positioned rearward of the front surface of the door 2.

The second finger 662 may have a shape corresponding to the slit 663. The second finger 662 may have a shape that bends forward and outward.

When the door 2 is fully open and the rotation of the lever 66 is restricted, the second finger 662 may be positioned forward of the rear surface of the door 2 or forward of the gasket 205. Alternatively, the second finger 662 may be positioned vertically below the gasket 205 in the above state.

A lever stopper 416 may be provided on the lower surface of the door 2. The lever 66 may include first and second contact portions 666 and 667. The lever stopper 416 and the first and second contact portions 666 and 667 are the same as those in the second embodiment described above with reference to FIGS. 8 and 9, and therefore, a description thereof will be omitted.

Referring to FIGS. 10, 20, and 21, the auto-closing device 4F can provide torque T that rotates the lever 61. The provision of torque T by the auto-closing device 4F to the lever 66 and the arrangement of the hinge shaft 32, the reference pin 35, and the center c of the lever 66 are identical to those of the second embodiment described above with reference to FIGS. 8 and 9, and therefore, a detailed description thereof will be omitted.

In FIGS. 21(A), (B), and (C) illustrate states in which the reference pin 35 is positioned on dotted lines 21(A), 21(B), and 21(C) of FIG. 20.

FIG. 21A illustrates a state in which the reference pin 35 enters the slit 663. When the door 2 is open, the clutch 44 can restrict the rotation of the shaft 43. However, during repeated opening and closing of the door 2, the rotation angle θ66 of the lever 66 with respect to the door 2 may deviate from a set angle (i.e., the locking angle described above). If the rotation angle of the lever 66 deviates from the locking angle described above, the door 2 is closed, and as the reference pin 35 passes through the third region 6633, the position of the lever 66 may be adjusted and the rotation angle of the clutch 44 may be aligned to a set angle.

FIG. 21B illustrates a state corresponding to FIG. 9A. In addition, as described above, the clutch 44 may restrict the rotation of the shaft 46, and the lever 66 may not automatically rotate with respect to the door 2. The rotation angle of the lever 66 in FIG. 21B may be referred to as the locking angle. During the closing process of the door 2, the reference pin 35 can slide along the second region 6632. During this process, the clutch 44 can release the restraint of the shaft 46.

The position of the reference pin 35 is fixed relative to the cabinet 10, and the door 2 rotates relative to the cabinet 10 as it closes, and thus a force Fm can be applied between the reference pin 35 and the lever 66. When the reference pin 35 is positioned in the second region 6632, the reference pin 35 contacts the first finger 661. As the door 2 closes, the reference pin 35 can press the first finger 661 such that the first finger 661 rotates forward. As the lever 66 rotates, restraint of the shaft 46 by the clutch (44) can be released.

In the eighth embodiment, the second region 6632 may be directed rearward and inward, unlike the second region 6132 of the second embodiment.

Therefore, compared to the second embodiment, in the eighth embodiment, even if the door 2 rotates slightly during the release of restraint of the clutch 44, the lever 44 can rotate significantly. Therefore, the release of the clutch 44 can be accomplished rapidly.

FIG. 21C illustrates a state corresponding to FIG. 9B. In the state of FIG. 21B in which the lever 66 is positioned at the locking angle, if the door 2 rotates further, the reference pin 35 rotates relatively along the second region 6632, allowing the lever 66 to rotate further. As the lever 66 rotates, the clutch 44 can gradually connect the spring 43 and the shaft 46. The rotation angle θ66 of the lever 66 in FIG. 21C can be referred to as the switching angle. At this time, the reference pin 35 may be located at the boundary between the first and second regions 6231 and 6232.

When the rotation angle θ66 of the lever 66 is the switching angle, the clutch 44 connects the spring 43 and the shaft 44, and thus the driver 40 rotates the lever 66, allowing the door 2 to close, as shown in FIG. 21D. At this time, the reference pin 35 can slide along the first region 6632.

As the door 2 closes, the second finger 662 presses the reference pin 35 forward. In the second embodiment, the second region 6632 may be formed to be curved, unlike the second region 6132 of the first embodiment. Therefore, when the lever 66 rotates and applies force to the reference pin 35, the reference pin 35 can slide smoothly.

The operations of the clutch 44, the lever 66, and the door 2 during the process in which the reference pin 35 slides along the first region 6631 are identical to those described with reference to FIG. 9B, and thus are omitted.

As shown in FIG. 21D, when the door 2 is closed, the reference pin 35 can contact the inner end of the slit 663. When the door 2 is closed, the second contact portion 667 can contact the stopper.

The door 2 can be opened in the order of (d), (c), (b), and (a) of FIG. 10 (excluding the force and direction indicated by the arrows). When the door 2 is opened, the rotation center c of the lever 66 moves forward, and since the reference pin 35 is fixed, the lever 66 rotates such that the fingers 661 and 662 face rearward.

If the door 2 is further opened from the state of FIG. 21A, the first contact portion 666 may contact the lever stopper 416, preventing the lever 61 from rotating further. The reference pin 35 may be released from the slit 663.

Hereinafter, the shapes of the slits 613, 623, 633, 643, 653, 663, and 53 will be described with reference to FIGS. 8, 11, 12, 18, 20, and 22.

The inner ends of the slits 613, 623, 633, 643, 653, and 663 can be determined based on the position of the reference pin 35 and the positions of the levers 61, 62, 63, 64, 65, 66, and 5 when the door 2 is closed. That is, the slits 613, 623, 633, 643, 653, 663, and 53 can be formed such that the inner ends are located at the position of the reference pin 35 when the door is closed.

The positions of the outer ends of the slits 613, 623, 633, 643, 653, 663, and 53 can be determined by the rotation angle of the levers 61, 62, 63, 64, 65, 66, and 5. That is, they can be determined based on the angle between the positions of the levers 61, 62, 63, 64, 65, 66, and 5 when the door 2 is closed and the position at which the levers are rotated to the maximum, i.e., the locking angle described above.

For example, the locking angles of the lever 61 of the second embodiment described above with reference to FIG. 8 may be the same as that of the lever 66 of the eighth embodiment described above with reference to FIG. 20, and the positions of the inner and outer ends of the respective slits 613 and 663 may be the same.

In the first and second embodiments described above, the outer ends of the slits 613 and 663 may be positioned rearward of the inner ends.

However, the shape of the slits 613 and 663 connecting the outer ends and inner ends may be formed in consideration of various functions.

For example, in the second embodiment described with reference to FIG. 8, the slit 613 may have a straight line shape connecting the outer end and the inner end. When the shape of the slit 613 is a straight line, the rotation angle of the lever 61 according to the rotation angle of the door 2 is easily maintained constant, and even if an error occurs, the operation of the lever 61 may not be affected.

For example, in the eighth embodiment described with reference to FIG. 20, the first region 6631 extending from the inner end and the second and third regions 6632 and 6633 extending from the outer end are not positioned on a straight line in the slit 663. For example, the first region 6631 may extend from the inner end in an arc shape and may be convex rearward. The second region 6632 may extend from the first region in an arc shape and may be convex rearward. Accordingly, when the clutch 44 releases restraint of the shaft 46 during the closing process of the door 2, the reference pin 35 can advantageously slide in the second region 6632 and the first finger 661 can advantageously press the reference pin 35. Furthermore, when the clutch 44 connects the shaft 46 and the spring 43, the reference pin 35 can advantageously slide in the first region 6631 and the second finger 662 can advantageously press the reference pin 35.

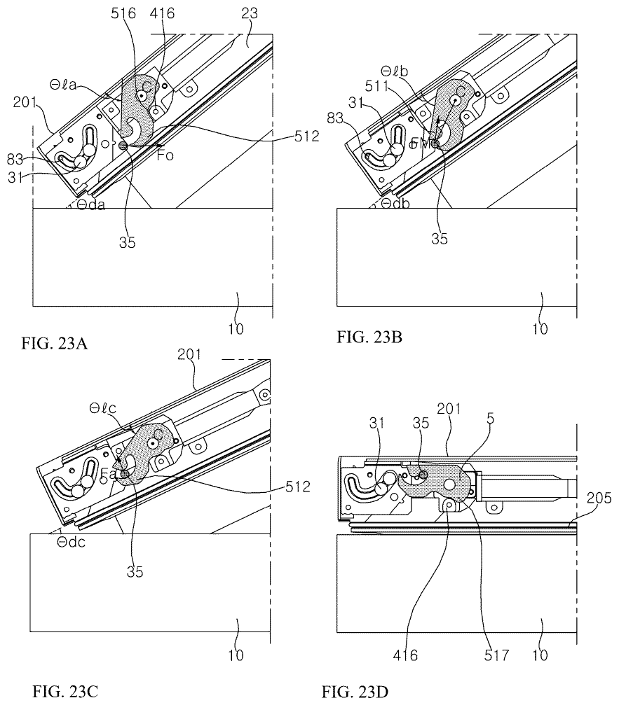

Hereinafter, the structure of the lever 5 of the auto-closing device 4 according to the first embodiment of the present disclosure and the operations of the lever 5 and the hinge 3 will be described with reference to FIGS. 22 and 23. The hinge 3 and guide member 8 of the present embodiment are identical to the hinge 3 and guide member 8 of the home appliance of the fifth embodiment described above with reference to FIGS. 12 to 15. However, the hinges 3 and 30 of different structures described above may also be applied.

The lever 5 of the refrigerator according to the first embodiment of the present disclosure may be rotatably provided on the bottom surface of the door 2. The lever 5 may include the slit 53 into which the reference pin 35 is inserted. The reference pin 35 may be secured to the cabinet 10, and the lever 5 may be provided on the door 2. The reference pin 35 may be inserted into the slit 53 of the lever 5 and may slide along the slit 53. When the door 2 rotates while the reference pin 35 is inserted into the slit 53, the lever 5 can rotate according to the rotation of the door 2. The rotation angle θ1a, θ1b, and θ1c of the lever 5 may be greater than the rotation angle θda, θdb, and θdc of the door 2.

Unlike the lever 61 of the second embodiment described above with reference to FIGS. 8 and 9, the lever 5 of the present embodiment includes the slit 53 having a bent shape. For example, the slit 53 may have a bent straight shape or a curved shape.

The lever 5 may include the finger 51 extending radially outward from the rotation center. The slit 53 may be formed in the finger 51.

The finger 51 may include first and second fingers 511 and 512. The slit 53 may be formed between the first and second fingers 511 and 512. The first finger 511 may be positioned forward of the slit 53, and the second finger 512 may be positioned rearward of the slit 532.

The slit 53 may include the first region 531 extending outward from the inner end of the slit 53 and the second region 532 extending outward from the first region 531.

The first region 531 is located at the inner end of the slit 53 and may extend rearward and outward. The second region 532 may extend from the first region 531 and may be formed to face forward and outward.

The first region 531 may extend in a curved shape. The first region 531 may have an arc shape. The center of curvature of the first region 531 may be located in the front of the slit 53.

Compared to the slit 653 of the sixth embodiment described above, the slit 53 of the present embodiment does not include a portion extending in the front-back direction. In addition, the slit 53 of the present embodiment does not include a portion extending in the tangential direction with respect to the rotational direction of the lever 5 compared to the slit 653 of the sixth embodiment described above. For example, the angle θ531 between the extension direction of the inner end of the first region 531 and the radial direction of the lever 5 may be an obtuse angle. That is, the angle between the center line of the first region 531 and the line connecting the center of the reference pin 35 and the rotation center C of the lever 5 when the door 2 is closed may be greater than 90 degrees. The angle may be less than 180 degrees.

Therefore, the rotational position of the lever 65 according to the rotation of the door 2 can be prevented from deviating from the design standard.

The second region 532 may extend in a curved shape. The second region 532 may have an arc shape. The center of curvature of the second region 532 may be located in the front of the slit 53.

The radius of curvature r1 of the first region 531 may be greater than the radius of curvature r2 of the second region 532.

The torque T of the auto-closing device 4, i.e., the torque T of the spring 53, may be proportional to the angle of rotation from the free state. The auto-closing device 4 rotates the lever 5, and the force exerted by the lever 5 on the reference pin 35 is equal to a value obtained by dividing the torque by the distance between the reference pin 35 and the rotation center of the lever.

The force exerted by the lever 5 on the reference pin 35 may be perpendicular to the surface where the reference pin 35 contacts the lever 5. That is, the force exerted by the lever 5 on the reference pin 35 may be directed toward the center of curvature of the slit 53. Among the forces exerted by the lever 5 on the reference pin 35, the component of the force parallel to the forward-backward direction of the door, which is the rotational radius of the lever 5, may serve as the force that closes the door 2 via the auto-closing device 4.

Meanwhile, at the point where the first region 531 and the second region 532 meet, the slit 53 may extend parallel to the longitudinal direction of the lever 5. That is, as shown in FIG. 22, the tangential direction at the point where the first and second regions 531 and 532 meet, relative to the position of the lever 5 in the closed door state, may be the left-right direction. If the inner end of the slit 53 extends parallel to the tangential direction of the rotational radius of the reference pin 35 and the forward-backward direction of the door, the torque of the auto-closing device 4 cannot be transmitted to the reference pin 35 when the reference pin 35 is positioned at that location.

Therefore, the more gently the slit 53 is bent, the more advantageous it is for the torque T of the auto-closing device 4 to be converted into force for closing the door 2.

As the reference pin 35 moves from the outer end to the inner end of the slit 53, the rotation angle of the lever 5 and the torque of the auto-closing device 4 gradually decrease. By designing the radius of curvature r1 of the first region 531 to be greater than the radius of curvature r2 of the second region 532, even if the torque is reduced, sufficient force can be provided to close the door 2 with the torque of the auto-closing device 4.

The slit 53 may include a third region 533. The third region 533 may extend from the second region 532 and be located at the outermost end of the slit 53.

The third region 533 may extend straight. The third region 533 may extend parallel to the outer end of the second region 532. The first finger 511 may include a straight portion 5113 forming the third region 533. Since the slit 53 includes the straight third region 533, the reference pin 31 may move smoothly along the slit 53 when the reference pin 31 enters the slit 53 during the closing process of the door 2.

If the outer end of the slit 53 is positioned in front of the first finger 511, when the reference pin 35 enters the slit 53 during the closing process of the door 2, the reference pin 35 may press the lever 5 backward. That is, the problem of the lever 5 rotating in the opposite direction may occur.

In addition, the larger the rotation angle of the lever 5 for releasing the restraint of the shaft 46 by the clutch 44, the less force may be required to release the restraint. Therefore, if the length of the slit 53 for releasing the restraint of the clutch 44 is formed short to prevent opposite rotation of the lever 5 described above, a relatively large force may be required to release the restraint of the clutch 44 during the closing process of the door 2.

The lever 5 of the present embodiment includes the third region 533 extending straight from the second region 532, thereby ensuring sufficient lengths of the second and third regions 532 and 533 for the process of releasing the clutch 44, while preventing the lever 5 from rotating in the opposite direction.

Meanwhile, the first region 531 may extend in a curved manner, with the outer end thereof which meets the second region 531 positioned rearward and the inner end thereof positioned forward. Accordingly, the slopes of the second region 532 and the first region 531 may be connected in a continuous or nearly continuous manner.

On the other hand, if the second region 532 does not have a curved portion and the straight portion of the third region 531 meets the first region 531, the sliding direction of the reference pin 35 may sharply change when the reference pin 53 enters the first region 531. In this case, the reference pin 35 may get caught in the slit 53 during the closing process of the door 2, generating noise.

In the lever 5 of the present embodiment, the second region 532 and the first region 531 of the slit 53 extend in a curved manner, and the slopes thereof are continuously connected, allowing the reference pin 35 to move smoothly along the slit 53.

The outer end 5123 of the second finger 532 may be curved. The outer end 5123 of the second finger 532 may have an arc shape. When the door 2 is opened, the reference pin 35 may move away from the outer end 5123 of the second finger 532 and rotate the lever 5, thereby inducing the latch 47 to be mounted on a second latch mounting portion 4638.

The lever 5 may be disposed between the front surface 201 and the rear surface 202 of the door 2. When the door 2 is closed, the front end of the lever 5 may extend parallel to the front surface of the door 2. The front end of the lever 5 may be positioned rearward relative to the front surface of the door 2.

The outer rear end of the lever 5 may extend in a direction intersecting the width direction of the door 2 such that the angle θ formed with respect to the width direction of the door 2 may be less than 90 degrees.

The angle θ may be the maximum rotation angle of the lever 5. That is, when the door 2 is opened to the maximum extent and the lever 61 is rotationally constrained (refer to FIG. 15A, the outer rear end of the lever 5 may be disposed parallel to the rear surface 202 of the door 2. At this time, the outer rear end 6122 of the lever 61 may be positioned forward of the rear surface of the door 2 or forward of the gasket 205 provided on the door 2.

A lever stopper 416 may be provided on the lower surface of the door 2. The lever 5 may include first and second contact portions 516 and 517. The lever stopper 416 and the first and second contact portions 516 and 517 are identical to those of the first embodiment described above with reference to FIGS. 7 and 8, and therefore, a detailed description thereof will be omitted.

The operations of the lever 5 and reference pin 35 of the auto-closing device 4 according to the degree of opening of the door 2 of the home appliance according to the first embodiment of the present disclosure will be described with reference to FIGS. 10, 21, and 22.

FIG. 23A illustrates a point in time when the reference pin 35 contacts the lever 5. When the clutch 44 is not in a designated position, the lever 5 and the outer end 5123 of the second finger contact each other, and the clutch 44 can be guided to the designated position. The “designated position” may refer to a case in which the rotation angle of the lever 5 is the aforementioned locking angle.

When the door 2 is open or the reference pin 35 is further rotated by the outer end 5213 of the second finger 512 and thus the clutch 44 is aligned at the designated position, the clutch 44 can restrain rotation of the shaft 46 to prevent the lever 5 from automatically rotating relative to the door 2.

For example, if the door 2 is open and the clutch 44 is less rotated than the designated position, when the door 2 closes and the reference pin 35 enters the slit 53, the outer end of the curved second finger 52 contacts the reference pin 35, allowing the lever to rotate further, thereby placing the clutch at the designated position.

For example, when the door 2 is closed, if the reference pin 35 is removed from the slit 53, and the clutch 44 is rotated less than the designated position, the reference pin 35 contacts the outer end 5123 of the second finger as the door 2 opens, allowing the lever 5 to rotate further, thereby allowing the clutch 44 to be positioned at the designated position.

In the process in which the clutch 44 is positioned at the designated position, the first contact portion 516 comes into contact with the stopper 416, preventing the lever 5 and the clutch 44 from rotating further than the designated position.

FIG. 23B illustrates a state in which the rotation angle θ1b of the lever 5 is the locking angle. In this case, the reference pin 35 may be positioned in the third region 533 of the slit 53. During the closing process of the door 2, the reference pin 35 can slide along the third area 533. During this process, the clutch 44 can release the restraint of the shaft 46.

When the door 2 is closed, a force Fm may be applied between the reference pin 35 and the lever 5. When the reference pin 35 is positioned in the third region 533, the reference pin 35 contacts the first finger 511. As the door 2 is closed, the reference pin 35 may press the first finger 511 such that the first finger 511 rotates forward. As the lever 5 rotates, the restraint of the shaft 46 by the clutch 44 can be released.

The third region 533 may face rearward and inward. Therefore, even if the door 2 rotates slightly during the release of the restraint of the clutch 44, the lever 44 may rotate significantly. Therefore, the restraint of the clutch 44 can be released rapidly.

FIG. 23C illustrates a state in which the rotation angle θ1c of the lever 5 is the switching angle. That is, as the door 2 is closed, the clutch 44 gradually connects the shaft 46 and the spring 43. In the state shown in FIG. 23C, the clutch 44 can connect the shaft 46 and the spring 43. At this time, the reference pin 35 may be located at the boundary between the second region 532 and the first region 531.

Since the clutch 44 connects the spring 43 and the shaft 44 in the state shown in FIG. 23C, the driver 40 can rotate the lever 5 to close the door 2. At this time, the reference pin 35 can slide relatively along the first region 532.

When the door 2 is closed, the second finger 52 presses the reference pin 35 forward. The second region 532 may be formed to be curved. Therefore, when the lever 5 rotates and applies force to the reference pin 35, the reference pin 35 can slide smoothly.

As shown in FIG. 15D, when the door 2 is closed, the reference pin 35 can contact the inner end of the slit 53. As shown in FIG. 15D, when the door 2 is closed, the second contact portion 517 can contact the stopper.

The door 2 can be opened in the order of (D), (C), (B), and (A) of FIG. 15 (excluding the force and direction indicated by the arrows). When the door 2 is opened, the rotation center c of the lever 5 moves forward, and since the reference pin 35 is fixed, the lever 5 rotates such that the finger 51 faces rearward.

When the door 2 is further opened beyond the state of FIGS. 15A to 15D(1), the first contact portion 516 contacts the lever stopper 416, and the lever 5 can no longer rotate. The reference pin 35 can be released from the slit 53.

In the present embodiment, when the reference pin 35 is positioned at the slit 53, the rotation angles θ1a, θ1b, and θ1c of the lever 5 with respect to the door 2 may be greater than the rotation angles θda, θdb, and θdc of the door with respect to the cabinet 10. For example, the locking angle θ1b of the present embodiment may be in the range of 45 to 50 degrees, and at this time, the angle θdb between the door 2 and the cabinet 10 may be in the range of 30 to 40 degrees. For example, the switching angle θ1c may be in the range of 28 to 40 degrees, and at this time, the angle θdc between the door 2 and the cabinet 10 may be in the range of 20 to 30 degrees. For example, when the reference pin 35 contacts the lever 5, the angle θ1a of the lever may be the same as the locking angle θ1b described above, and the angle θda of the door may be in the range of 35 to 45 degrees.

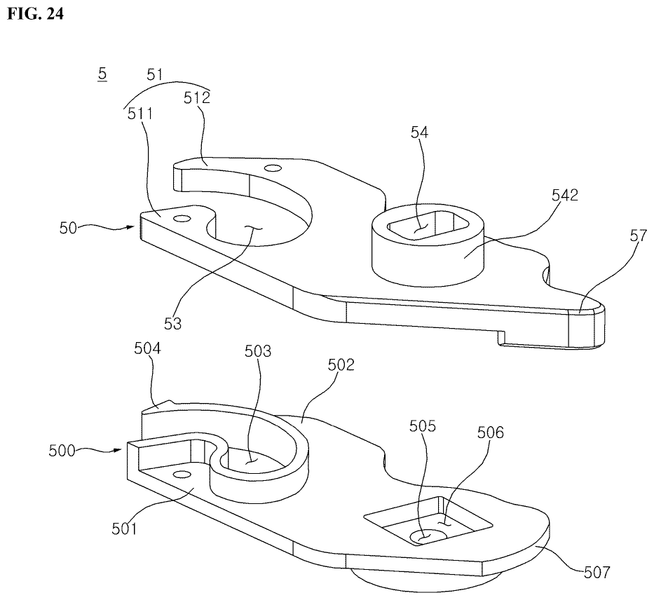

Referring to FIG. 24, the lever (5) according to an embodiment of the present disclosure may include the cam 57. The cam 57 may protrude radially outward from the rotation center of the lever 5. The cam 57 may be inclined so as to face rearward as it goes outward radially.

The cam 57 of the levers 5, 61, 62, 63, 64, 65, and 66 is not shown in the drawings for the above-described embodiments, and these drawings illustrate the operations of the reference pin 35, the slit 53, and the finger 510. That is, the above-described levers 5, 61, 62, 63, 64, and 65 may also include the cam 57. In addition, they may include all the features of the lever 5 described below.

The lever 5 may include a lever body 50. The lever body 50 may include the finger 51, the slit 53, and the cam 57 described above.

The shaft insertion hole 54 described above may be formed in the lever body 50. A rim 542 may protrude from the lever body 50. The rim 542 may protrude upward from the lever body 50. The shaft insertion hole 54 may have a shape that penetrates the lever body 50 and the rim 542.

The lever 5 may include a lever cap 500. The lever cap 500 may be coupled to the lever body 50. The lever cap 500 may have a shape corresponding to the lever body 50.

The lever cap 500 may include a first finger cap 501 coupled to the first finger 511 and a second finger cap 502 coupled to the second finger 512.

A slit cover 504 may protrude upward along the inner edges of the first and second finger caps 501 and 502. The slit cover 504 may be inserted into the slit 53 of the lever body 50. A slit 503 may be formed on the inner side of the slit cover 504, and the reference pin 35 may be inserted into the slit 503.

The lever cover 500 may include a rim receiving portion 506. The rim 562 protruding downward from the lever body 50 may be inserted into the rim receiving portion 506.

The lever cover 500 may include a fastening hole 505. The fastening hole 505 may be formed in the rim receiving portion 506.

The fastening hole 505 may penetrate the lever cover 500 vertically. A fastening member may penetrate the fastening holes 505 and 56 of the lever cover 500 and the lever body 50 and be inserted into the fastening hole 466 of the shaft 46, thereby coupling the lever 5 and the shaft 46.

The outer end of the cam 57 of the lever cover 500 may be positioned inward from the cam 57. That is, the cam 57 may be formed solely by the lever body 50.

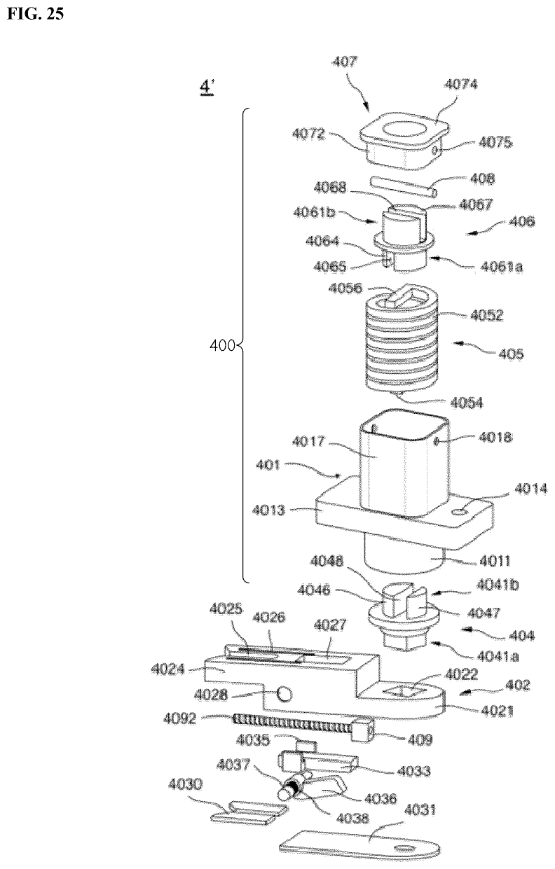

Hereinafter, an auto-closing device 4′ according to another embodiment of the present disclosure will be described with reference to FIG. 25.

Referring to FIG. 25, the auto-closing device 4′ of the present embodiment may include a driver 400 and a lever 402. The driver 400 may include a housing 401 and a spring 405. The housing 401 may form the outer shape of the driver 400.

The lever 402 may be rotatably coupled to the driver 400. The lever 402 may rotate horizontally about a rotational center line extending vertically.

The spring 405 may be, for example, a torsion spring. The spring 405 may include a spiral portion 4052 formed by winding a wire multiple times.

The spring 405 may include one end 4056 extending from the upper end of the spiral portion and the other end 4054 extending from the lower end of the spiral portion 4052. The one end 4056 and the other end 4054 may extend inwardly along the radius of the spiral portion.

The driver 400 may further include a first connector 404 connected to the lever 402. The first connector 404 may be disposed within the housing 401 and may have a portion protruding outward from the housing 401 to be connected to the lever 402.

The first connector 404 may be connected to the lever 402. The first connector 404 may rotate along with the lever 402.

The first connector 404 may connect the spring 405 and the lever 402. The first connector 404 may include a lever coupling portion 4041a and a first spring coupling portion 4041b.

The other end 4054 of the spring 405 may be coupled to the first connector 404. For example, the other end 4054 of the spring 405 may be inserted into a coupling space 4048 of the first spring coupling portion 4041b.

When the other end 4054 is accommodated in the coupling space 4048, the first spring coupling portion 4041b may be accommodated within the spiral portion 4052. That is, the spiral portion 4052 may surround the first spring coupling portion 4041b and be coupled to the first spring coupling portion 4041b.

The spring coupling portion 4041b may include a first rib 4046 and a second rib 4047 that are spaced apart from each other in the horizontal direction. The coupling space 4048 may be formed between the first rib 4046 and the second rib 4047. The other end 4054 of the spring 405 may be accommodated in the coupling space 4048.

The lever coupling portion 4041a may be formed with a non-circular horizontal cross-section to prevent the lever coupling portion 4041a from spinning while coupled with the lever 402. For example, the lever coupling portion 4041a may be formed with a polygonal horizontal cross-section.

The driver 400 may further include a second connector 406 coupled with the spring 405. One end 4056 of the spring 405 may be coupled with the second connector 406. The second connector 406 may be formed in a similar shape to the first connector 405.

The second connector 406 may include a second spring coupling portion 4061a and a pin coupling portion 4061b. The second connector 406 may further include a partition plate 4062 positioned between the second spring coupling portion 4061a and the pin coupling portion 4061b.

The pin coupling portion 4061b may be positioned on the upper side of the partition plate 4062 and the second spring coupling portion 4061a may be positioned on the lower side.

The second spring coupling portion 4061a may include a first rib 4063 and a second rib 4064 that are spaced apart from each other in the horizontal direction. A first coupling space 4065 may be formed between the first rib 4063 and the second rib 4064.

The one end 4056 of the spring 405 may be inserted into the first coupling space 4065. When the one end 4056 is accommodated in the first coupling space 4065, the second spring coupling portion 4061a may be accommodated inside the spiral portion 4052. That is, the spiral portion 4052 can surround the second spring coupling portion 4061a and be coupled with the second spring coupling portion 4061a.

The pin coupling portion 4061b may include a third rib 4066 and a fourth rib 4067 that are spaced apart from each other in the horizontal direction. A second coupling space 4068 may be formed between the third rib 4066 and the fourth rib 4067.

The driver 400 may further include an upper cap 4074 covering an upper opening of the housing 401.

The upper cap 4074 may include a cap body 4072 having a hollow space 4073 formed therein, and a flange 4074 extending horizontally from the upper end of the cap body 4072.

The cap body 4072 may be inserted into the interior of the housing 401, and the flange 4074 may be mounted on the upper surface of the housing 401. The pin coupling 4061b may be inserted into the hollow space 4073.

The driver 400 may further include a fixing pin 408 for fixing the upper cap 4074 to the housing 401.

A pair of first pin holes 4018 through which the fixing pin 408 passes may be formed in the housing 401. The cap body 4072 may include a pair of second pin holes 4075 through which the fixing pin 408 passes.

The fixing pin 408 may be inserted into the second coupling space 4068. That is, the fixing pin 408 may pass through one first pin hole 4018 and one second pin hole 4075, then pass through the second coupling space 4068, and then pass through another second pin hole 4075 and another first pin hole 4018.

The upper cap 407 and the second connector 406 are fixed in position while connected to the housing 401 by the fixing pin 408. That is, rotation of the upper cap 407 and the second connector 406 is restricted by the fixed pin 408.

That is, in the present embodiment, one end 4056 of the spring 405 is a fixed end, and the other end 4054 is a movable end. Therefore, while the one end 4056 is fixed, the other end 4054 can rotate along with the lever 402.

When the other end 4054 of the spring 405 rotates in one direction while the one end 4056 of the spring 405 is fixed, the spring 405 accumulates elastic force. The elastic force accumulated in the spring 405 can act on the lever 402 such that the lever 402 rotates in the other direction opposite to the one direction.

The elastic force accumulated by the spring 405 in this manner acts on the door 2 during the closing process of the door 2, thereby automatically closing the door 2 at a predetermined position.

The structure for fixing the one end 4056 of the spring 405 described above is exemplary, and various fixing structures may be applied. For example, the one end 4056 of the spring 405 is directly fixed to the housing 401 or the upper cap 407.

The housing 401 may include a first body 4011 that accommodates the first connector 404 and a second body 4017 that accommodates the spring 405.

The second body 4017 may be provided on the upper side of the first body 4011. The space within the second body 4017 where the spring 405 is disposed and the space within the first body 4011 where the first connector 404 is disposed may be connected to each other.

The housing 401 may include a laterally protruding coupling portion 4013. The coupling portion 4013 may be coupled to the door 2. A fastening hole 4014 is formed in the coupling portion 4013, and a fastening member may pass through the fastening hole 4014 and be coupled to the door 2, thereby fastening the auto-closing device 40 to the door 2.

The lever 402 may include a coupling slot 4022 coupled to the lever coupling portion 4041a. The coupling slot 4022 may be formed in a shape and size corresponding to the lever coupling portion 4041a.

The lever 402 may include a first portion 4021 that is coupled with the first connector 404. The first portion 4021 may be provided with the coupling slot 4022.

The lever 402 may include the first portion 4021 and a second portion 4024. The second portion 4024 may have an upper surface and two sides, and may have an open lower surface. Furthermore, the lower surface of the first portion 4021 may also be open.

The second portion 4024 may be stepped relative to the first portion 4021. The lower surface of the lever 402 may be stepped. The lower surface of the lever 402 may be covered by a first cover 4030 and a second cover 4031.

The lever 402 may include a slit 4025 through which the reference pin 35 may be accommodated and moved. For example, the slit 4025 may be formed in the central portion of the second portion 4024.

The slit 4025 may extend in the longitudinal direction of the lever 402. For example, the slit 4025 may extend horizontally from the end of the second portion 4024 toward the first portion 4022. The reference pin 35 may be withdrawn from the slit 4025 when the first door 21 is opened by a reference angle or more, and may be inserted into the slit 4025 when the first door 21 is opened by the reference angle or less or closed.

The driver 400 may further include a sliding member 4033 slidably connected to the lever 402. The sliding member 4033 may slide horizontally on the lever 402. That is, the sliding member 4033 may move in a direction intersecting the rotational center line of the lever 402.

For example, the sliding member 4033 may be disposed to be slidable within a space formed by the second portion 4024.

The sliding member 4033 may include a guide rib 4035 for guiding sliding of the sliding member 4033. The second portion 4024 may include a rib slot 4026 in which the guide rib 4035 is accommodated.

An elastic member that provides elastic force to the sliding member 4033 may be provided within the lever 402. The elastic member may be, for example, a coil spring 4092. In addition, a spring holder 409 that supports the coil spring 4092 may be provided within the lever 402.

The sliding member 4033 may include an extension portion 4034 for supporting the coil spring 4092. For example, the sliding member 4033 may be movable in a first direction (longitudinal direction), and the extension portion 4034 may extend from the sliding member 4033 in a direction intersecting the first direction. Accordingly, the coil spring 4092 may be positioned on one side of the sliding member 4033. As another example, a pair of coil springs 4092 may be positioned on both sides of the sliding member 4033 to elastically support the sliding member 4033.

The coil spring 4092 may provide elastic force to the sliding member 4033 in a direction in which a portion of the sliding member 4033 is exposed to the slit 4025.

The direction in which a portion of the sliding member 4033 is exposed to the slit 4025 is a direction in which the sliding member 4033 moves away from the rotation center of the lever 402.

The sliding member 4033 may move in both forward and reverse directions. The direction in which the sliding member 4033 moves away from the rotation center of the lever 402 may be referred to as the forward direction.

If no external force is applied to the sliding member 4033, the sliding member 4033 is positioned in the slit 4025 by the elastic force of the coil spring 4092.

The auto-closing device 4′ may further include a locking member 4036 rotatably provided on the lever 402. For example, the locking member 4036 may be positioned within the lever 402.

The locking member 4036 is coupled to a shaft 4037, and the shaft 4037 may be inserted into a shaft hole 4028 of the second portion 4024 and rotated. The shaft 4037 may extend, for example, in the horizontal direction. That is, the locking member 4036 can rotate around a rotation center line extending in the horizontal direction.

The shaft 4037 may be coupled to the lever 402 at a position lower than the sliding member 4033.

Accordingly, the locking member 4036 can rotate along with the lever 402, and can also rotate relative to the lever 402 with respect to the shaft 4037.

The locking member 4036 may be connected to an elastic member. The elastic member may be, for example, a torsion spring 4038. One end of the torsion spring 4038 may be connected to the locking member 4036, and the other end thereof may be supported by or in contact with the second portion 4024. Other types of springs besides the torsion spring 4038 may also provide elastic force to the locking member 4036.

The lever 402 may have an opening 4027 through which the locking member 4036 passes. For example, the opening 4027 may be formed on the upper surface of the second portion 4024.

The locking member 4036 receives elastic force from the torsion spring 4038 in a direction in which the locking member 4036 rotates upward by penetrating the opening 4027 while installed on the lever 402.

The locking member 4036 may be rotated by the sliding member 4033 when the sliding member 4033 moves in the reverse direction. If no external force is applied to the locking member 4036 (when the sliding member 4033 has moved in the forward direction to a stop position), a portion of the locking member 4036 may be coupled to the housing 401 by penetrating the opening 4027 of the lever 402.

The housing 401 may include a locking groove 4015 that accommodates the locking member 4036 protruding upward from the lever 402. For example, the locking groove 4015 may be provided on the lower surface of the fastening extension portion.

When the locking member 4036 is inserted into the locking groove 4015, the lever 402 cannot rotate with respect to the housing 401. On the other hand, when the locking member 4036 is removed from the locking groove 4015, the lever 402 can rotate with respect to the housing 401.

Therefore, in the present embodiment, the state in which the locking member 4036 is inserted into the locking groove 4015 may be referred to as a locked state of the lever 402. The state in which the locking member 4036 is removed from the locking groove 4015 may be referred to as an unlocked state of the lever 402.

Additionally, in the present embodiment, the direction in which the locking member 4036 rotates to be inserted into the locking groove 4015 may be referred to as a locking direction, and the direction in which the locking member 4036 rotates to be removed from the locking groove 4015 may be referred to as an unlocking direction.

The embodiments or other embodiments of the present disclosure described above are not mutually exclusive or distinct. The embodiments or other embodiments of the present disclosure described above may be combined or incorporated into the configurations or functions thereof.

For example, a configuration A described in a specific embodiment and/or drawing may be combined with a configuration B described in another embodiment and/or drawing. In other words, even if a combination between components is not directly described, this means that combination is possible, except where combination is described as impossible.

The above detailed description should not be construed as limiting in any respect, but rather as illustrative. The scope of the present disclosure should be determined by a reasonable interpretation of the appended claims, and all modifications within the scope of equivalents of the present disclosure are intended to be included within the scope of the present disclosure.

What is claimed is:

1. A home appliance comprising:
a cabinet defining a storage compartment open to a front side;
a door rotatably provided at a front of the cabinet and configured to open and close at least a portion of the storage compartment;
a hinge fixed to the cabinet and including a hinge shaft that rotatably supports the door and a reference pin spaced apart from the hinge shaft; and
an auto-closing device configured to apply a force to the door in a closing direction, the auto-closing device comprising:
a driver, and
a lever rotatably coupled to the driver and receiving torque from the driver, the lever including a slit into which the reference pin is inserted,
wherein the slit includes a first region in which the reference pin is positioned based on the door being closed, the first region extending rearward away from a rotation center of the lever.

2. The home appliance of claim 1, wherein the slit further includes a second region extending away from the rotation center of the lever from the first region,
wherein the second region extends forward away from the rotation center of the lever.

3. The home appliance of claim 2, wherein a radius of curvature of the first region is greater than a radius of curvature of the second region.

4. The home appliance of claim 2, wherein the slit further includes a third region extending from the second region and open to an outside.

5. The home appliance of claim 4, wherein the third region extends in a straight line.

6. The home appliance of claim 2, wherein the driver comprises:
a torsion spring having one end fixed;
a lever shaft rotating integrally with the lever; and
a clutch configured to selectively connect or disconnect the torsion spring and the lever shaft.

7. The home appliance of claim 6, wherein the clutch connects the torsion spring and the lever shaft from a state in which the door is closed until a state in which a rotation angle of the lever reaches a first angle, and disconnects the torsion spring from the lever shaft in response to the rotation angle of the lever being greater than the first angle,
wherein the rotation angle of the lever is defined based on a position of the lever in a state in which the door is closed.

8. The home appliance of claim 7, the clutch restricts rotation of the lever shaft based on the rotation angle of the lever being a second angle greater than the first angle.

9. The home appliance of claim 8, wherein the reference pin is positioned in the first region of the slit in response to the rotation angle of the lever being less than the first angle, and is positioned in the second region of the slit in response to the rotation angle of the lever being between the first angle and the second angle.

10. The home appliance of claim 1, wherein a rotation angle of the lever is greater than a rotation angle of the door based on the reference pin being positioned in the slit, the rotation angle of the lever is defined based on a state in which the door is closed, and the rotation angle of the door is defined as an angle between the door and the cabinet.

11. The home appliance of claim 1, wherein the door includes a guide member into which the hinge shaft is inserted, and the lever is spaced apart from the guide member in a width direction of the door.

12. The home appliance according to claim 11, wherein the hinge shaft may include a first hinge shaft and a second hinge shaft that are spaced apart from each other in a horizontal direction,
wherein the guide member may include a shaft insertion groove into which the first and second hinge shafts are inserted and which extends in a curved shape, and
wherein, based on the door rotating relative to the cabinet, the first and second hinge shafts may slide relative to the shaft insertion groove such that a position of a rotation center of the door is changed.

13. The home appliance of claim 1, wherein a front portion of the lever includes an edge parallel to a front surface of the door in a state in which the door is closed.

14. The home appliance of claim 1, wherein the door includes a cover protruding downward from a lower end of the door and positioned forward of a front portion of the lever.

15. The home appliance of claim 1, wherein a rear portion of the lever includes an edge parallel to a rear surface of the door in a state in which the door is open and the reference pin is removed from the slit.

16. The home appliance of claim 1, wherein the door includes a stopper protruding downward from a lower surface of the door and positioned behind the lever, and the lever is positioned below the door, and
wherein the lever comprises:
a first contact portion contacting the stopper in a state in which the door is closed, and
a second contact portion contacting the stopper in a state in which the door is open and the reference pin is removed from the slit.

17. The home appliance of claim 1, wherein the hinge comprises:
a coupling portion including a fastening hole through which a fastening member passes and secured to the cabinet; and
a supporter protruding forward from the coupling portion, and
wherein the reference pin protrudes from the supporter and is spaced apart from the fastening hole in a width direction of the cabinet.

18. The home appliance of claim 1, wherein an angle between a center line of the first region and a line connecting a center of the reference pin and the rotation center of the lever in a state in which the door is closed is greater than 90 degrees and less than 180 degrees.

19. The home appliance of claim 1, wherein the first region includes a portion extending in a direction perpendicular to a radial direction of the lever.

20. The home appliance of claim 18, wherein the reference pin comprises:
a first reference pin positioned in the first region in a state in which the door is closed; and
a second reference pin positioned in a second region in a state in which the door is closed.
